(19) United States
(12) Patent Application Publication
(10) Pub. No.: US 2006/0114885 A1
(43) Pub. Date: Jun. 1, 2006

(54) Network interworking system and method for providing seamless voice service and short message service between wireless communication networks

(75) Inventors: Hye-Won Baek, Seongnam-si (KR); Joon-Ho Park, Seongnam-si (KR); Dong-Soo Park, Seoul (KR); Dae-Seok Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/269,892

(22) Filed: Nov. 9, 2005

(30) Foreign Application Priority Data
Nov. 9, 2004 (KR) 90811/2004
Nov. 23, 2004 (KR) 96343/2004

(51) Int. Cl. H04L 12/66

(52) U.S. Cl. 370/352

(57) ABSTRACT

A network interworking system is provided for connecting a voice call between a mobile terminal in a wireless packet network and a mobile terminal in a mobile communication network. A home location register (HLR) registers therein location information of terminals and a subscriber profile. An access point controller (APC) converts data between the mobile communication network and the wireless packet network upon receipt of an origination message including a terminal identifier of a called terminal, and transmits a call connection request to the called terminal. A mobile switching center (MSC) detects a location of the called terminal through the HLR upon receipt of the call connection request from the APC, and transmits a paging message to the detected location of the called terminal. A base station system (BSS) transmits the paging message from the MSC in the mobile communication network to the called terminal.

### CROSS-REFERENCE TO RELATED APPLICATIONS

This application claims the benefit under 35 U.S.C. §119(a) of Korean Patent Application No. 2004-90811 entitled “Network Interworking System and Method for Providing Seamless Voice Service and Short Message Service between Wireless Communication Networks” filed in the Korean Intellectual Property Office on Nov. 9, 2004, and Korean Patent Application No. 2004-96343 entitled “Network Interworking System and Method for Providing Seamless Voice Service and Short Message Service between Wireless Communication Networks” filed in the Korean Intellectual Property Office on Nov. 23, 2004, the entire disclosures of both of which are hereby incorporated by reference.

### BACKGROUND OF THE INVENTION

1. Field of the Invention

The present invention relates generally to a network interworking system and method for providing wireless communication service between heterogeneous/homogeneous networks. In particular, the present invention relates to a network interworking system and method for providing seamless voice service and Short Message Service (SMS) service between heterogeneous/homogeneous networks.

2. Description of the Related Art

Mobile communication networks providing conventional circuit-switched voice service are classified into Frequency Division Multiple Access (FDMA) networks, Time Division Multiple Access (TDMA) networks, and Code Division Multiple Access (CDMA) networks according to their communication methods. In an FDMA network, a predetermined frequency band is divided into a plurality of frequency channels and the frequency channels are individually allocated to subscribers. In a TDMA network, one frequency channel is time-shared by a plurality of subscribers. In a CDMA network, a plurality of subscribers use the same frequency band in the same time band and every subscriber is allocated its own unique code.

With the rapid progress of communication technologies, mobile communication networks have risen to the level of providing high-speed data service in which subscribers can enjoy not only general voice service, but also multimedia service such as e-mail, still image and moving image services, using a mobile terminal. As is well known to those skilled in the art, 3^{rd} generation (3G) mobile communication systems supporting both voice service and packet service are generally classified into synchronous CDMA2000 1× systems and asynchronous Universal Mobile Telecommunication System (UMTS) systems.

Existing voice service is provided through a circuit switched network such as a public switched telephone network (PSTN), and the above-described mobile communication networks also provide circuit-switched voice service. Packet service has been provided through an Internet Protocol (IP) network such as the Internet. Recently, however, Voice over Internet Protocol (VoIP), which is a well-known technology, has been proposed to provide voice service through the IP network. The number of VoIP users is rapidly increasing due to several advantages. As IP networks such as the Internet have developed and the 56-Kbps voice bandwidth limit of the circuit switched network has been overcome, high-quality voice calls have been enabled and subscribers can make inexpensive international calls with minimal fees. In addition, VoIP service can provide various application solutions and additional services.

Conventionally, VoIP service was provided only through wired networks to which a personal computer could be connected. Recently, however, active research is being conducted to provide VoIP service based on a Session Initiation Protocol (SIP) even through wireless packet networks such as a Wireless Local Area Network (WLAN) and a Wireless Broadband Internet (WiBro) for providing portable Internet service using a frequency of 2.3 GHz. In addition, research is being carried out on a so-called dual-mode terminal that is capable of accessing both the mobile communication network and the wireless packet network. However, both the general mobile communication network-based voice service provided through a mobile switching center (MSC) and the VoIP-based voice service provided through the wireless packet network are provided only through their authorized networks, and the foregoing research has failed to provide a network interworking scheme for allowing a subscriber to receive a call originated from the mobile communication network in the wireless packet network, or allowing the subscriber to receive a call originated from the wireless packet network in the mobile communication network, thereby making it difficult to provide seamless voice service to the service subscriber. Accordingly, there is a need for a system and method for providing seamless voice service to the service subscriber in a heterogeneous network environment.

The existing Short Message Service (SMS) is provided through the circuit-switched mobile communication network. Recently, although active research is being conducted on the wireless packet network such as the WLAN and the WiBro for providing portable Internet service using a frequency of 2.3 GHz, the research has failed to propose a scheme for providing the SMS service used in the mobile communication network through the wireless packet network. Even though an SMS message of a subscriber is preferably transmitted to a called terminal using the general packet service, it is difficult to provide retransmission service like the SMS service used in the mobile communication network when the called terminal cannot receive a call due to, for example, its power being off.

Even though it is assumed for illustration purposes that SMS service is possible in the wireless packet network, because the SMS service in the mobile communication network and the SMS service in the wireless packet network are provided through heterogeneous networks, it is difficult to receive an SMS message originated from the mobile communication network in the wireless packet network, or to receive an SMS message originated from the wireless packet network in the mobile communication network. Therefore, in the wireless communication system in which the mobile communication network and the wireless packet network coexist, it is hard to provide stable SMS service to the service subscribers. Accordingly, there is a need for a system and method for providing seamless voice service between a general mobile communication network and a wireless packet network.

### SUMMARY OF THE INVENTION

It is, therefore, an object of embodiments of the present invention to substantially solve the above and other problems, and to provide a network interworking system and method for providing seamless voice service between a mobile communication network that provides circuit-switched voice service and a wireless packet network that provides Voice over Internet Protocol (VoIP)-based voice service.

It is another object of embodiments of the present invention to provide a network interworking system and method between heterogeneous networks, for receiving a call originated from a mobile communication network in a wireless packet network, and for receiving a call originated from the wireless packet network in the mobile communication network.

It is further another object of embodiments of the present invention to provide an access point controller (APC) apparatus of a wireless packet network, for providing stable voice service between a mobile communication network and the wireless packet network.

It is yet another object of embodiments of the present invention to provide an APC apparatus of a wireless packet network, for providing stable voice service between wireless packet networks.

It is still another object of embodiments of the present invention to provide a method and system for registering/deregistering a location of a mobile terminal in a wireless packet network interworking with a mobile communication network.

It is still another object of embodiments of the present invention to provide a network interworking system and method between heterogeneous networks, for providing seamless Short Message Service (SMS) service between a mobile communication network and a wireless packet network.

According to one aspect of the present invention, there is provided a network interworking system for connecting a voice call from a calling terminal in a wireless packet network that provides voice over Internet protocol (VoIP) service to a called terminal in a mobile communication network that provides circuit-switched voice service. The system comprises a home location register (HLR) for registering therein location information of terminals and a subscriber profile; an access point controller (APC) including a gateway for connection with the mobile communication network, for converting data between the mobile communication network and the wireless packet network using the gateway upon receipt of an origination message including a terminal identifier of a called terminal, and transmitting a call connection request to the called terminal. A mobile switching center (MSC) detects a location of the called terminal through the HLR upon receipt of the call connection request to the called terminal from the APC, and transmits a paging message to the detected location of the called terminal. A base station system (BSS) transmits the paging message from the MSC in the mobile communication network to the called terminal.

According to another aspect of the present invention, a network interworking system connects a voice call from a calling terminal in a mobile communication network that provides circuit-switched voice service to a called terminal in a wireless packet network that provides voice over Internet protocol (VoIP) service. The system comprises a home location register (HLR) for registering therein location information of terminals and a subscriber profile. A base station system (BSS) receives an origination message including a terminal identifier of the called terminal from the calling terminal, and delivers the received origination message to a mobile switching center (MSC). The MSC transmits a call connection request to a location of the called terminal, detected through the HLR, upon receiving the origination message. An access point controller (APC) includes a gateway for connection with the mobile communication network, for converting data between the mobile communication network and the wireless packet network using the gateway upon receipt of the call connection request to the called terminal from the MSC, and transmitting a termination message for the voice call connection to the called terminal.

According to another aspect of the present invention, a network interworking system connects a voice call from a calling terminal in a first wireless packet network to a called terminal in a second wireless packet network, each of the first and second wireless packet networks providing voice over Internet protocol (VoIP) service. The system comprises a home location register (HLR) for registering therein location information of terminals and a subscriber profile. A first access point controller (APC) includes a gateway for connection with the first wireless packet network, for converting data between the first and second wireless packet networks using the gateway upon receipt of an origination message including a terminal identifier of the called terminal. A first mobile switching center (MSC) detects a location of the called terminal through the HLR upon receipt of a call connection request to the called terminal from the first APC, and transmits a paging message to the detected location of the called terminal. A second MSC transmits a request message for the call connection to the called terminal upon receipt of the call connection request to the called terminal from the first MSC. A second APC transmits a termination message to the called terminal upon receipt of the request message from the second MSC.

According to yet another aspect of the present invention, there is provided a network interworking method for connecting a voice call from a calling terminal in a: wireless packet network that provides voice over Internet protocol (VoIP) service to a called terminal in a mobile communication network that provides circuit-switched voice service. The method comprises registering location information of terminals and a subscriber profile in a home location register (HLR). An origination message is transmitted including a terminal identifier of the called terminal to an access point controller (APC) in the wireless packet network. Data is converted between the mobile communication network and the wireless packet network, and a call connection request is transmitted to the called terminal. A location of the called terminal is detected in the mobile communication network through the HLR, and a paging message is transmitted to the detected location of the called terminal.

According to still another aspect of the present invention, a network interworking method connects a voice call from a calling terminal in a mobile communication network that provides circuit-switched voice service to a called terminal in a wireless packet network that provides voice over Internet protocol (VoIP) service. The method comprises registering location information of terminals and a subscriber profile in a home location register (HLR). An origination message is transmitted including a terminal identifier of the called terminal to a base station system (BSS) in the mobile communication network. A call connection request is transmitted to a mobile switching center (MSC) based on the mobile identifier of the called terminal. A location of the called terminal in the wireless packet network is detected through the HLR, and a paging message is transmitted to the detected location of the called terminal. Data is converted between the mobile communication network and the wireless packet network, and a call connection request is transmitted to the called terminal.

According to still another aspect of the present invention, an access point controller (APC) apparatus is included in a network interworking system for connecting a voice call between a mobile terminal in a wireless packet network that provides voice over Internet protocol (VoIP) service and a mobile terminal in a mobile communication network that provides circuit-switched voice service. The apparatus comprises a signaling gateway including a session initiation protocol (SIP) message handler for handling transmission/reception of SIP-based messages for voice call connection with mobile terminals in the wireless packet network and the mobile communication network, and a mobile switching center (MSC) interworking unit for exchanging a message including call setup information between the mobile terminals, with an MSC. A media gateway is connected to the signaling gateway via a predetermined control protocol, for performing data conversion between the wireless packet network and the mobile communication network.

According to still another aspect of the present invention, a location registration method is provided for a mobile terminal located in a wireless packet network in a network interworking system having an access point controller (APC) for handling call connection between a first mobile terminal in the wireless packet network and a second mobile terminal in a mobile communication network. The method comprises transmitting, by the first mobile terminal, a session initiation protocol (SIP) registration request message including its own mobile identification number (MIN) and electronic serial number (ESN) to the APC. The APC transmits a location update request message to a mobile switching center (MSC). The MSC transmits a location registration request message including the MIN and the ESN to a home location register (HLR). The HLR determines whether the first mobile terminal is a registered terminal by analyzing the MIN and the ESN, and transmits a location registration response message including a corresponding subscriber profile to the MSC if the first mobile terminal is a registered terminal. The MSC registers a location of the first mobile terminal in a visitor location register (VLR) based on the subscriber profile.

According to still another aspect of the present invention, a network interworking system provides short message service (SMS) service from a calling terminal in a wireless packet network to a called terminal in a circuit-switched mobile communication network. The system comprises a home location register (HLR) for registering therein location information of terminals and a subscriber profile. An access point controller (APC) includes a gateway for connection with the mobile communication network, for converting data between the mobile communication network and the wireless packet network using the gateway upon receipt of an origination message including an SMS message and a terminal identifier of the called terminal from the calling terminal, and transmitting an SMS delivery message including the SMS message and the terminal identifier. An origination mobile switching center (MSC) detects a location of the called terminal through the HLR upon receipt of the origination message including the terminal identifier of the called terminal from the APC, and transmits a first delivery message to the detected location of the called terminal. An SMS center (SMSC), upon receiving the first delivery message, transmits a second delivery message including the SMS message and the terminal identifier to the location of the called terminal, detected through the HLR. A termination MSC, upon receiving the second delivery message, transmits a paging message indicating arrival of the SMS message to the called terminal.

According to still another aspect of the present invention, a network interworking system provides short message service (SMS) service from a calling terminal in a circuit-switched mobile communication network to a called terminal in a wireless packet network. The system comprises a home location register (HLR) for registering therein location information of terminals and a subscriber profile. An origination mobile switching center (MSC) transmits a first delivery message including an SMS message and a terminal identifier of the called terminal, upon receiving an origination message including the SMS message and the terminal identifier of the called terminal from the calling terminal through a base station system (BSS). An SMS center (SMSC), upon receiving the first delivery message, transmits a second delivery message including the SMS message and the terminal identifier to a location of the called terminal, detected through the HLR. A termination MSC, upon receiving the second delivery message, transmits a paging request message indicating arrival of the SMS message to the called terminal. An access point controller (APC) includes a gateway for connection with the mobile communication network, for converting data between the mobile communication network and the wireless packet network using the gateway upon receipt of the paging request message from the termination MSC, and transmits a termination message including the SMS message and the terminal identifier.

According to still another aspect of the present invention, a network interworking system provides short message service (SMS) service from a calling terminal in a first wireless packet network to a called terminal in a second wireless packet network. The system comprises a home location register (HLR) for registering therein location information of terminals and a subscriber profile. An origination access point controller (APC) transmits an SMS delivery message including an SMS message and a terminal identifier of the called terminal upon receipt of an origination message including the SMS message and the terminal identifier from the calling terminal. An origination mobile switching center (MSC), upon receiving the SMS delivery message, transmits a first delivery message including the SMS message and the terminal identifier. An SMS center (SMSC), upon receiving the first delivery message, transmits a second delivery message including the SMS message and the terminal identifier to a location of the called terminal, detected through the HLR. A termination MSC, upon receiving the second delivery message, transmits a request message indicating arrival of the SMS message to the called terminal. A termination APC includes a gateway for connection with the mobile communication network, for converting data between the mobile communication network and the wireless packet network using the gateway upon receipt of the request message, and transmits a termination message including the SMS message and the terminal identifier.

According to still another aspect of the present invention, a network interworking method provides short message service (SMS) service from a calling terminal in a wireless packet network to a called terminal in a circuit-switched mobile communication network. The method comprises registering location information of terminals and a subscriber profile in a home location register (HLR). An origination message is transmitted including an SMS message of the calling terminal and a terminal identifier of the called terminal to an access point controller (APC). The APC transmits an SMS delivery message to an origination mobile switching center (MSC) upon receipt of the origination message. The origination MSC transmits a first delivery message including the SMS message and the terminal identifier to an SMS center (SMSC) upon receipt of the SMS delivery message. The SMSC transmits a second delivery message including the SMS message and the terminal identifier to a termination MSC upon receipt of the first delivery message, and the termination MSC transmits a request message indicating arrival of the SMS message to the called terminal through a base station system (BSS) upon receipt of the second delivery message.

According to still another aspect of the present invention, a network interworking method provides short message service (SMS) service from a calling terminal in a first wireless packet network to a called terminal in a second wireless packet network. The method comprises registering location information of terminals and a subscriber profile in a home location register (HLR). An origination message is transmitted including an SMS message of the calling terminal and a terminal identifier of the called terminal to an access point controller (APC). The APC transmits an SMS delivery message to an origination mobile switching center (MSC) upon receipt of the origination message. The origination MSC transmits a first delivery message including the SMS message of the calling terminal and the terminal identifier of the called terminal to an SMS center (SMSC) upon receipt of the SMS delivery message. The SMSC transmits a second delivery message including the SMS message and the terminal identifier to a termination MSC upon receipt of the first delivery message. The termination MSC transmits a paging request message indicating arrival of the SMS message to the APC upon receipt of the second delivery message. The APC transmits a termination message including the SMS message and the terminal identifier to the called terminal upon receipt of the paging request message.

According to still another aspect of the present invention, a network interworking method provides short message service (SMS) service from a calling terminal in a first wireless packet network to a called terminal in a second wireless packet network. The method comprises registering location information of terminals and a subscriber profile in a home location register (HLR). An origination message is transmitted including an SMS message of the calling terminal and a terminal identifier of the called terminal to an origination access point controller (APC). The origination APC transmits an SMS delivery message to an origination mobile switching center (MSC) upon receipt of the origination message. The origination MSC transmits a first delivery message including the SMS message and the terminal identifier to an SMS center (SMSC) upon receipt of the SMS delivery message. The SMSC transmits a second delivery message including the SMS message and the terminal identifier to a location of the called terminal, detected through the HLR, upon receipt of the first delivery message. A termination MSC transmits a request message indicating arrival of the SMS message to a termination APC upon receipt of the second delivery message. The termination APC transmits a termination message to the called terminal upon receipt of the request message.

According to still another aspect of the present invention, an access point controller (APC) apparatus is included in a network interworking system for providing short message service (SMS) service between a mobile terminal in a wireless packet network and a mobile terminal in a mobile communication network. The apparatus comprises a signaling gateway comprising a session initiation protocol (SIP) message handler for handling transmission/reception of SIP-based messages for delivery of an SMS message between mobile terminals in the wireless packet network and the mobile communication network, and a mobile switching center (MSC)/SMS center (SMSC) interworking unit for exchanging an SMS delivery message including an SMS message and a terminal identifier of a mobile terminal to which the SMS message is targeted, with an MSC. A media gateway is connected to the signaling gateway via a predetermined control protocol, for performing data conversion between the wireless packet network and the mobile communication network.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a configuration of a network interworking system between heterogeneous networks according to an embodiment of the present invention;

FIG. 2 is a block diagram illustrating a structure of an access point controller (APC) according to an embodiment of the present invention;

FIG. 3A is a network configuration diagram illustrating a location registration process for a mobile terminal, performed in a wireless packet network according to an embodiment of the present invention;

FIG. 3B is a signaling diagram illustrating a location registration process for a mobile terminal, performed in a wireless packet network according to an embodiment of the present invention;

FIG. 4A is a network configuration diagram illustrating a location deregistration process for a mobile terminal, performed in a wireless packet network according to an embodiment of the present invention;

FIG. 4B is a signaling diagram illustrating a location deregistration process for a mobile terminal, performed in a wireless packet network according to an embodiment of the present invention;

FIG. 5A is a network configuration diagram illustrating a call setup process from a wireless packet network to a mobile communication network according to an embodiment of the present invention;

FIG. 5B is a signaling diagram illustrating a call setup process from a wireless packet network to a mobile communication network according to an embodiment of the present invention;

FIG. 6A is a network configuration diagram illustrating a call setup process from a mobile communication network to a wireless packet network according to an embodiment of the present invention;

FIG. 6B is a signaling diagram illustrating a call setup process from a mobile communication network to a wireless packet network according to an embodiment of the present invention;

FIG. 7A is a network configuration diagram illustrating a call setup process between wireless packet networks belonging to different domains according to an embodiment of the present invention;

FIG. 7B is a signaling diagram illustrating a call setup process between wireless packet networks belonging to different domains according to an embodiment of the present invention;

FIG. 8 is a block diagram illustrating an exemplary configuration of a network interworking system for providing SMS service between heterogeneous networks according to another embodiment of the present invention;

FIG. 9 is a block diagram illustrating a structure of the APC shown in FIG. 8;

FIG. 10A is a network configuration diagram illustrating an SMS message transmission process from a wireless packet network to a mobile communication network according to another embodiment of the present invention;

FIG. 10B is a signaling diagram illustrating an SMS message transmission process from a wireless packet network to a mobile communication network according to another embodiment of the present invention;

FIG. 11A is a network configuration diagram illustrating an SMS message transmission process from a mobile communication network to a wireless packet network according to another embodiment of the present invention;

FIG. 11B is a signaling diagram illustrating an SMS message transmission process from a mobile communication network to a wireless packet network according to another embodiment of the present invention;

FIG. 12A is a network configuration diagram illustrating an SMS message transmission process between wireless packet networks belonging to different domains according to another embodiment of the present invention; and

FIG. 12B is a signaling diagram illustrating an SMS message transmission process between wireless packet networks belonging to different domains according to another embodiment of the present invention.

Throughout the drawings, like reference numbers should be understood to refer to like elements, features and structures.

### DETAILED DESCRIPTION OF EXEMPLARY EMBODIMENTS

Several exemplary embodiments of the present invention will now be described in detail with reference to the annexed drawings. In the following description, a detailed description of known functions and configurations incorporated herein has been omitted for clarity and conciseness.

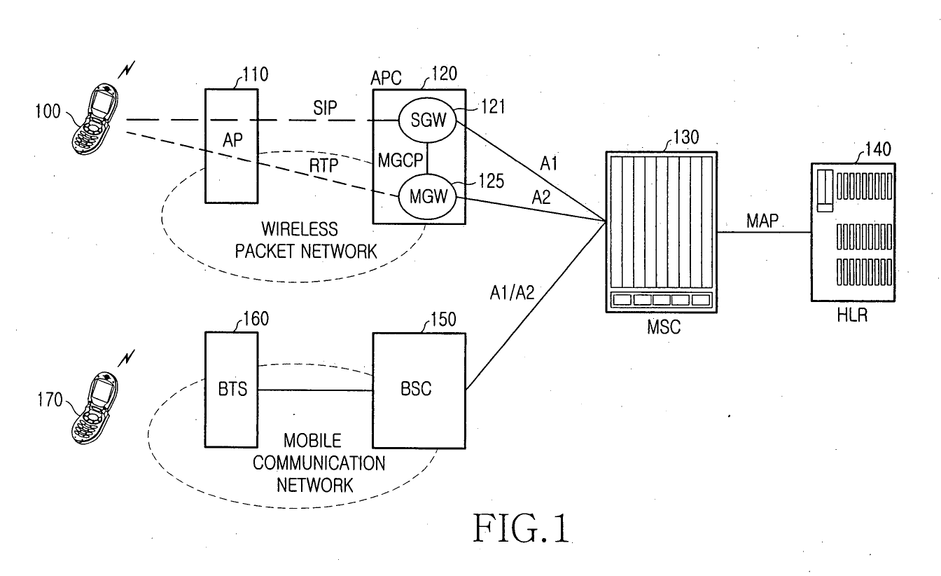

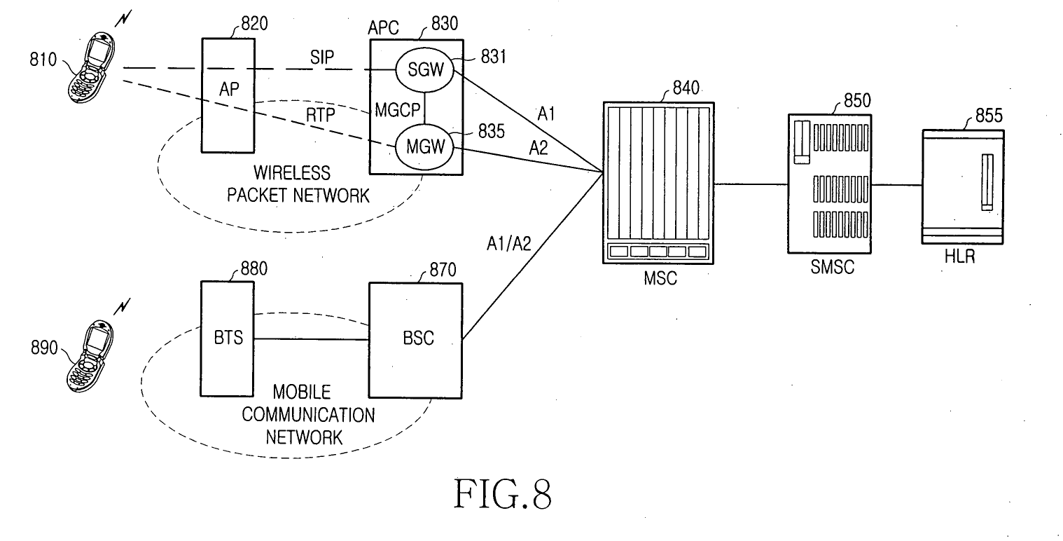

Herein, with reference to FIGS. 1 through 7, a description will be made of a first embodiment of the present invention for connecting a voice call between a wireless packet network and a voice communication network or connecting a voice call between wireless packet networks. With reference to FIGS. 8 through 12, a description will be made of a second embodiment for transmitting a Short Message Service (SMS) message between a wireless packet network and a voice communication network or transmitting an SMS message between wireless packet networks.

FIG. 1 is a block diagram illustrating a configuration of a network interworking system between a mobile communication network and a wireless packet network, for providing voice service, according to an embodiment of the present invention.

In FIG. 1, a wireless packet network comprises substantially all wireless networks that are capable of providing not only IP-based packet service but also VoIP service to subscribers, such as an IEEE 802.1x or IEEE 802.2x-based WLAN or an IEEE 802.16e-based WiBro network. In addition, a mobile communication network refers to a conventional wireless network for providing circuit-switched voice service through a mobile switching center (MSC). Further, mobile terminals (MT) 100 and 170 comprise not only dedicated terminals for accessing only one of a particular mobile communication network and a wireless packet network and performing communication with the corresponding network, but can also comprise dual-mode terminals that are capable of accessing the general mobile communication network and a wireless packet network such as WLAN or WiBro. Such mobile terminals may include and suitable device such as a cellular phone, personal digital assistant (PDA), palm-top computer, and so on.

Herein, the dual-mode terminal can be, for example, a terminal that is capable of making an individual access to a corresponding network during every mode switching, and also a terminal for a communication system supporting, for example, home LAN service for installing a wireless packet network having narrower coverage in a cell region of the mobile communication network, in which a subscriber currently receiving circuit-switched communication service can receive packet-switched communication service after moving to the wireless packet network and also, a subscriber currently receiving the packet-switched communication service can receive the circuit-switched communication service after moving to coverage of the mobile communication network, thereby providing seamless service to the subscribers.

For convenience of explanation, in FIG. 1, mobile terminals are divided into a first mobile terminal MT1 100 for accessing a wireless packet network and receiving VoIP service from the wireless packet network, and a second mobile terminal MT2 170 for accessing a mobile communication network and receiving voice service from the mobile communication network via an MSC. The VoIP service and voice service can comprise various additional services in addition to the basic origination/termination service. The first mobile terminal MT1 100 accesses the wireless packet network using a SIP, and the SIP refers to a protocol used in an Internet multimedia subsystem (IMS) for allowing a mobile terminal to access a core network of another communication network such as a mobile communication network or a PSTN through a gateway and providing IP-based communication service to subscribers.

In an exemplary embodiment of the present invention, the first mobile terminal MT1 100 uses a Mobile Identification Number (MIN) or an International Mobile Subscriber Identity (IMSI) as a terminal identifier. Further, the first mobile terminal MT1 100 uses the terminal identifier for a SIP Uniform Resource Locator (URL), includes at least one of an Electronic Serial Number (ESN), a MIN and an IMSI in a specific field of a SIP Registration Request message during location registration, and transmits the SIP Registration Request message to an access point controller (APC) 120 described in greater detail below. In an exemplary embodiment of the present invention, it will be assumed for illustration purposes that the MIN is used as the terminal identifier, but the present invention is not limited thereto.

For origination request, the first mobile terminal MT1 100 can transmit an ESN along with a SIP URL. The ESN is used to authenticate an authorized subscriber in a home location register (HLR), and the ESN can be optionally included in an origination message. In addition, the first mobile terminal MT1 100 transmits a SIP Invite Request message for requesting call setup to the APC 120 during origination, and receives a SIP Invite Request message of the other party's terminal delivered from the APC 120 during termination.

In the wireless packet network of FIG. 1, the first mobile terminal MT1 100 accesses the wireless packet network through an access point (AP) 110 for connecting a wireless network to a wire network, and the APC 120 for controlling packet communication, and receives not only packet service but also VoIP service from the wireless packet network. Herein, the first mobile terminal. MT1 100 using the VoIP service sets up a call to a mobile switching center (MSC) 130 through the SIP-based APC 120, and performs voice communication with another mobile terminal in the wireless packet network or the second mobile terminal MT2 170 in the mobile communication network.

The APC 120 communicates with the first mobile terminal MT1 100 using SIP signaling, communicates with the first mobile terminal MT1 100 over a bearer using a Real Transport Protocol (RTP) voice frame, and performs tightly interworking with the MSC 130 using an A1/A2 interface and a Signaling System No. 7 (SS7) protocol. The APC 120 includes a signaling gateway (SGW) 121 for handling transmission of SIP messages for subscriber's call setup/release, and a media gateway (MGW) 125 for connecting/disconnecting a bearer for user traffic transmission.

In the mobile communication network of FIG. 1, the second mobile terminal MT2 170 accesses the mobile communication network via a base transceiver subsystem (BTS) 160 and a base station controller (BSC) 150 for controlling the BTS 160, and receives the circuit-switched voice service from the mobile communication network. The BTS 160 and the BSC 150 constitute a wireless access network of the mobile communication network based on a CDMA2000 1× standard or a UMTS standard. Herein, the second mobile terminal MT2 170 using the voice service sets up a call through the MSC 130 and performs voice communication with the first mobile terminal MT1 100 in the wireless packet network.

In FIG. 1, the APC 120 of the wireless packet network and the BSC 150 of the mobile communication network are connected to the same MSC 130. In this case, if the first mobile terminal MT1 100 requests call setup to the second mobile terminal MT2 170, the MSC 130 receives call setup information from the first mobile terminal MT1 100 in the wireless packet network through a SIP message, and delivers a Paging Request message to the second mobile terminal MT2 170. If the second mobile terminal MT2 170 responds to the call request, the MSC 130 receives a Paging Response message from the second mobile terminal MT2 170 and informs the first mobile terminal MT1 100 of the receipt of the Paging Response message.

If the second mobile terminal MT2 170 in the mobile communication network requests call setup to the first mobile terminal MT1 100 in the wireless packet network, the MSC 130 receives call setup information from the second mobile terminal MT2 170 in the mobile communication network and delivers a Paging Request message to the first mobile terminal MT1 100. If the first mobile terminal MT1 100 responds to the call request, the MSC 130 receives a Paging Response message from the first mobile terminal MT1 100 and informs the second mobile terminal MT2 170 of the receipt of the Paging Response message.

On the contrary, if the APC 120 in the wireless packet network and the BSC 150 in the mobile communication network are connected to different MSCs, the MSCs perform the following operations. For convenience, an MSC connected to the APC 120 will be referred to as a first MSC 130 and an MSC connected to the BSC 150 will be referred to as a second MSC 131.

If the first mobile terminal MT1 100 in the wireless packet network requests call setup to the second mobile terminal MT2 170 in the mobile communication network, the first MSC 130 transmits an Initial Address Message (IAM) message to the second MSC 131, which is an MSC in the called side. Then, the second MSC 131 delivers a Paging Request message to the second mobile terminal MT2 170 using call setup information included in the IAM message. If the second mobile terminal MT2 170 responds to the call request, the second MSC 131 delivers an Answer Message (ANM) message, which is an Off-Hook message, to the first MSC 130, which is an MSC in the calling side, to inform the first MSC 130 of the call connection with the second mobile terminal MT2 170. The IAM message is used for SS7 signaling during Integrated Service Digital Network User Part (ISUP) call setup.

If the second mobile terminal MT2 170 in the mobile communication network requests call setup to the first mobile terminal MT1 100 in the wireless packet network, the second MSC 131 transmits an IAM message to the first MSC 130, which is an MSC in the called side. Then, the first MSC 130 delivers a SIP Invite Request message to the first mobile terminal MT1 100 using call setup information included in the IAM message. If the first mobile terminal MT1 100 responds to the call request, the second MSC 131 receives an ANM message, which is an Off-Hook message, from the first MSC 130, and informs the second mobile terminal MT2 170 of the call connection with the first mobile terminal MT1 100.

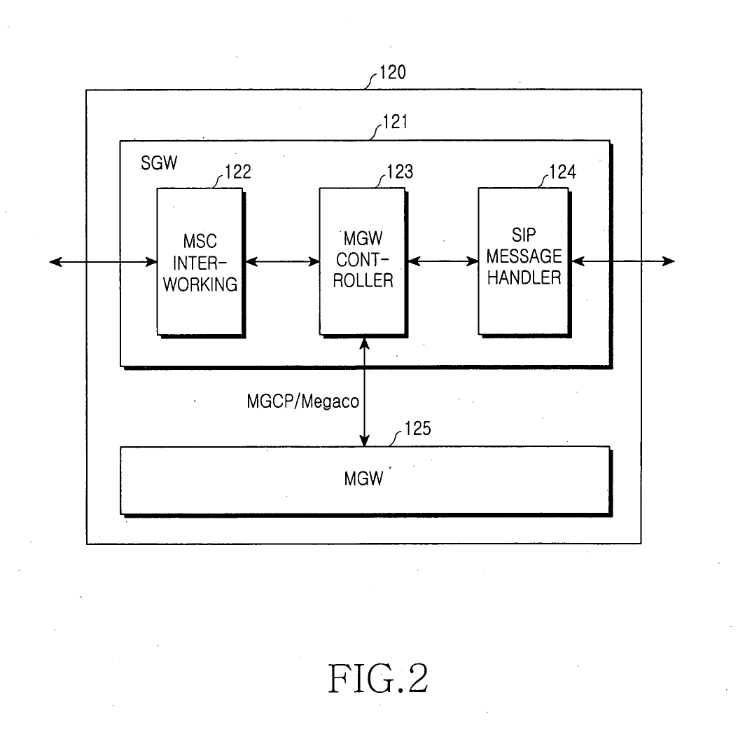

With reference to FIG. 2, a detailed description will now be made of the APC 120.

FIG. 2 is a block diagram illustrating a structure of an APC according to an embodiment of the present invention. The APC 120 comprises an SGW 121 for handling transmission of SIP messages for subscriber's call setup/release, and an MGW 125, connected to the SGW 121 via a Media Gateway Control Protocol (MGCP)/MEGACO, well known to those skilled in the art as a gateway control protocol, for performing data conversion (or data interpretation) between a mobile communication network and a wireless packet network.

The SGW 121 comprises an MSC interworking unit 122, an MGW controller 123, and a SIP message handler 124.

The MSC interworking unit 122 performs interworking with an MSC 130 to provide voice service supported in the mobile communication network to a subscriber of the wireless packet network. The MSC interworking unit 122 preferably uses an A1/A2 interface for interworking with the MSC 130.

The SIP message handler 124 handles SIP messages used for connecting or releasing a call to the first mobile terminal MT1 100 and for providing voice service.

For call connection from the wireless packet network to the mobile communication network, upon receiving information indicating receipt of a SIP Invite Request message including a MIN of a called terminal from the SIP message handler 124, the MSC interworking unit 122 transmits a message including call setup information to the MSC 130 that has completed allocation of circuit identity codes (CIC). For call connection from the mobile communication network to the wireless packet network, upon receiving a message including call setup information from an MSC 131 in which a called terminal is located, the MSC interworking unit 122 transmits a SIP Invite Request message to the corresponding called terminal via the SIP message handler 124.

Upon receiving a call connection or disconnection signal from the SIP message handler 124 or the MSC interworking unit 122, the MGW controller 123 exchanges control signals for connecting or disconnecting a bearer with the MGW 125.

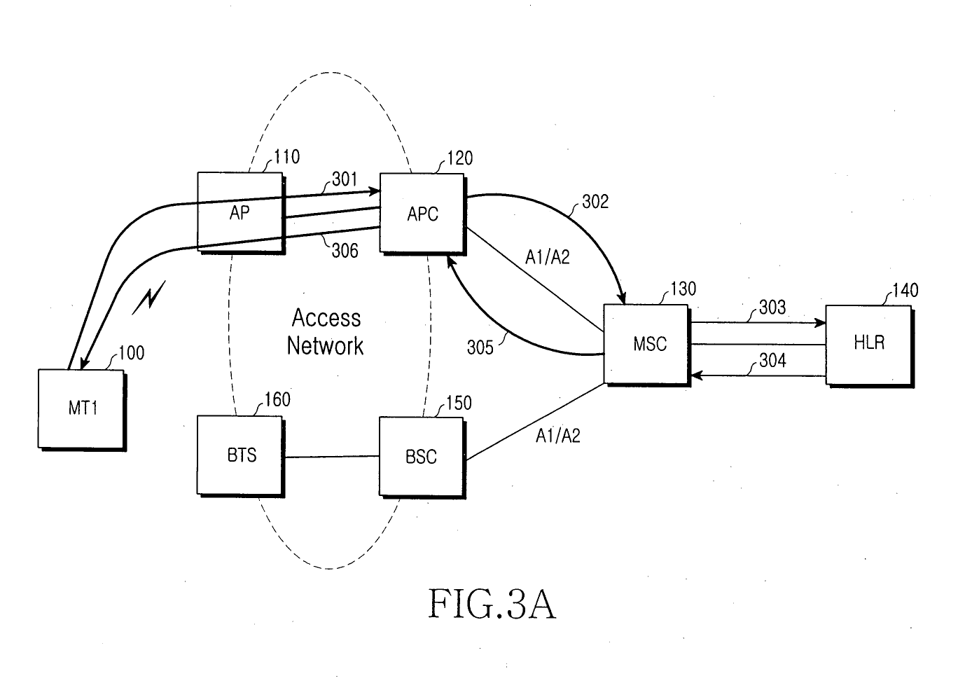

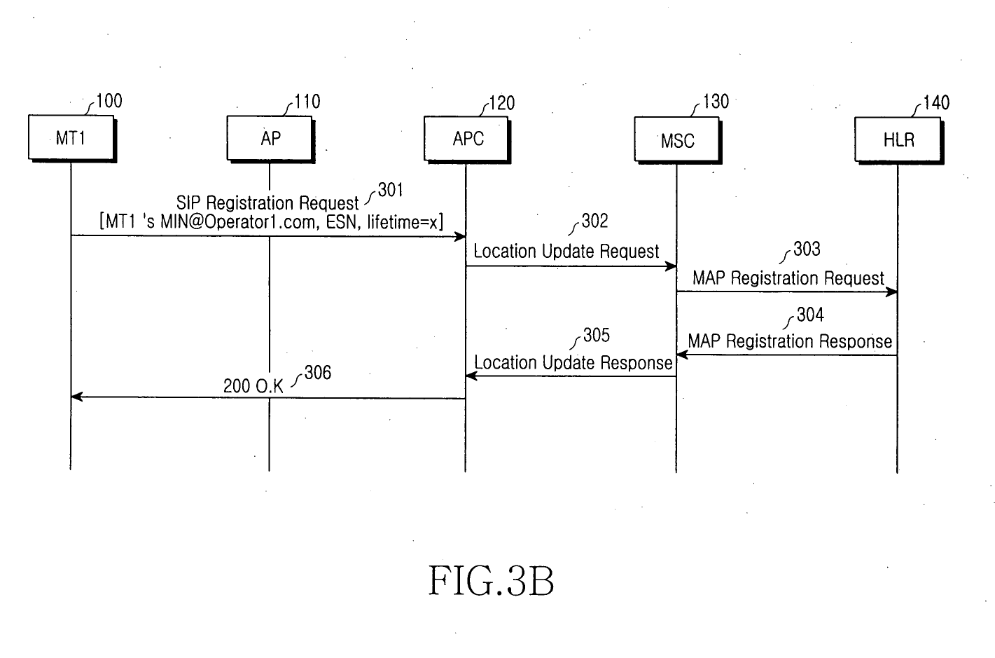

With reference to FIGS. 3 through 7, a detailed description will now be made of an exemplary location registration/deregistration operation for a mobile terminal, an exemplary origination/termination operation between a wireless packet network and a mobile communication network, and an exemplary origination/termination operation between wireless packet networks, all of the operations being performed through the network interworking system of FIG. 1. In FIGS. 3 through 7, an access network comprises both a wireless packet network and a mobile communication network, to each of which a mobile terminal is connected.

FIG. 3A is a network configuration diagram illustrating a location registration process for a mobile terminal, performed in a wireless packet network according to an embodiment of the present invention, and FIG. 3B is a signaling diagram illustrating the location registration process.

In step 301, a first mobile terminal MT1 100 transmits a SIP Registration Request message with lifetime=x including, for example, its own MIN and ESN to an APC 120 via an AP 110 when it is powered on in a wireless packet network. The SIP Registration Request message with lifetime=x further includes a lifetime field indicating a terminal's location registration period, which is set to ‘x’ (lifetime=x). Herein, the MIN is preferably transmitted in a URL form of, for example, MIN@operator1.com.

Upon receiving the SIP Registration Request message with lifetime=x, the APC 120 transmits in step 302 a Location Update Request message to an MSC 130 for location registration for the first mobile terminal MT1 100. Then the MSC 130 transmits in step 303 a MAP Registration Request message including an MIN and an ESN for location registration for the first mobile terminal MT1 100 to an HLR 140 to request transmission of a subscriber profile. In step 304, the HLR 140 transmits a subscriber profile for the first mobile terminal MT1 100 to the MSC 130 through a MAP Registration Response message. Then the MSC 130 stores the corresponding subscriber profile in a visitor location register (VLR), performing location registration. Herein, the MAP Registration Request/Response messages are transmitted/received using, for example, an interim standard-41 (IS-41) protocol.

After completing the location registration using the received MAP Registration Response message, the MSC 130 transmits in step 305 a Location Update Response message to the APC 120. Then the APC 120 transmits in step 306 a SIP OK message (or 200 O.K message) to the first mobile terminal MT1 100, indicating the successful completion of the location registration for the first mobile terminal MT1 100.

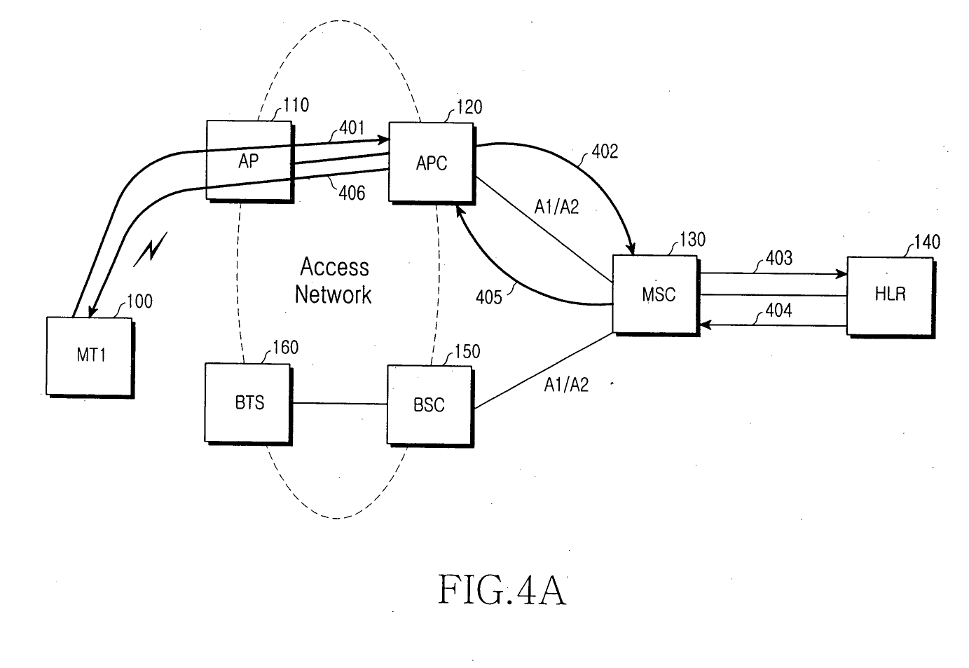

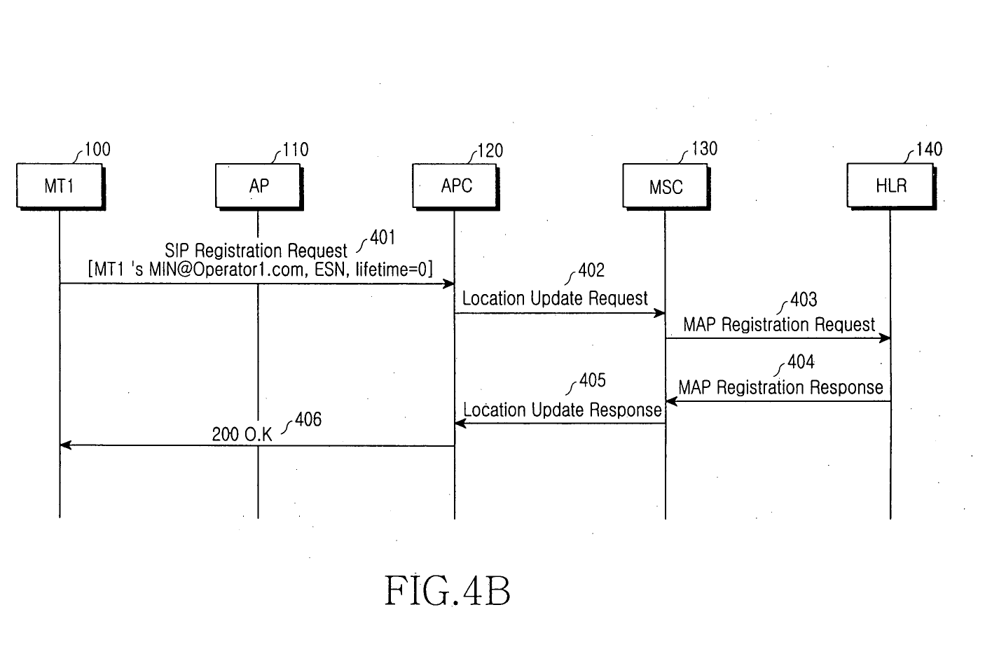

FIG. 4A is a network configuration diagram illustrating a location deregistration process for a mobile terminal, performed in a wireless packet network according to an embodiment of the present invention, and FIG. 4B is a signaling diagram illustrating the location deregistration process.

In step 401, a first mobile terminal MT1 100 transmits a SIP Registration Request message with lifetime=0 including, for example, its own MIN and ESN to an APC 120 via an AP 110 when it is powered Off in a wireless packet network. The SIP Registration Request message with lifetime=0 further includes a lifetime field indicating a terminal's location registration period, which is set to ‘0’ (lifetime=0), and the MIN is preferably transmitted in a URL form of, for example, MIN@operator1.com.

Upon receiving the SIP Registration Request message with lifetime=0, the APC 120 transmits in step 402 a Location Update Request message to an MSC 130 for location deregistration for the first mobile terminal MT1 100. Then the MSC 130 transmits in step 403 a MAP Registration Request message including an MIN and an ESN for location deregistration for the first mobile terminal MT1 100 to an HLR 140 to request transmission of a subscriber profile. In step 404, the HLR 140 transmits a subscriber profile for the first mobile terminal MT1 100 to the MSC 130 through a MAP Registration Response message. Then the MSC 130 performs a location deregistration process by analyzing a corresponding subscriber profile location-registered in a VLR. Herein, the MAP Registration Request/Response messages are transmitted/received using, for example, an IS-41 protocol.

After completing the location deregistration using the received MAP Registration Response message, the MSC 130 transmits in step 405 a Location Update Response message indicating the completion of the location deregistration to the APC 120. In step 406, the APC 120 transmits a SIP OK message (or 200 O.K message) to the first mobile terminal MT1 100, indicating the successful completion of the location deregistration for the first mobile terminal MT1 100.

Because a location registration/deregistration process for the second mobile terminal MT2 170 connected to a mobile communication network is well known to those skilled in the art, a detailed description thereof will be omitted herein for simplicity.

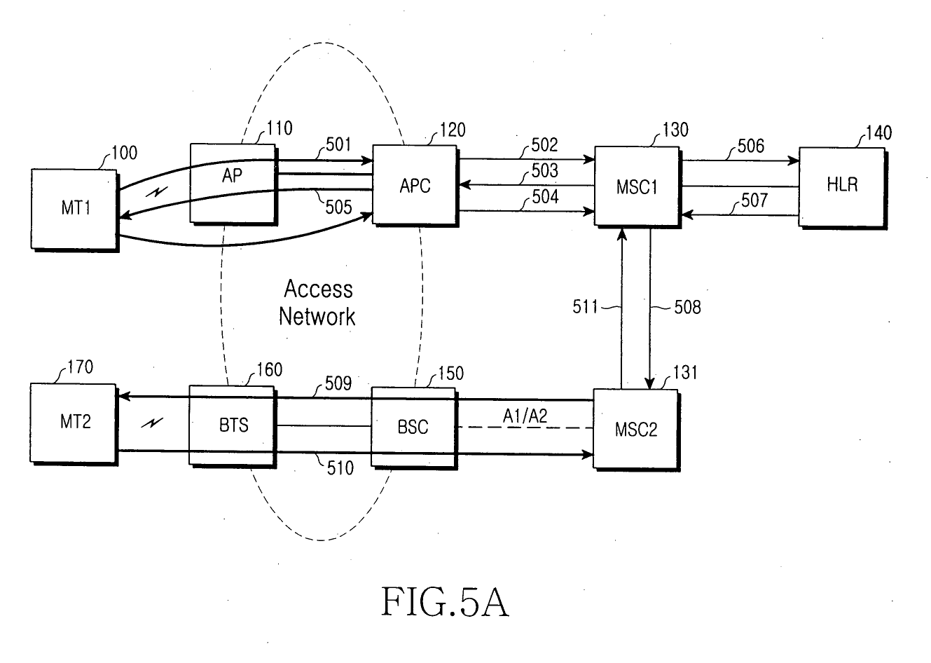

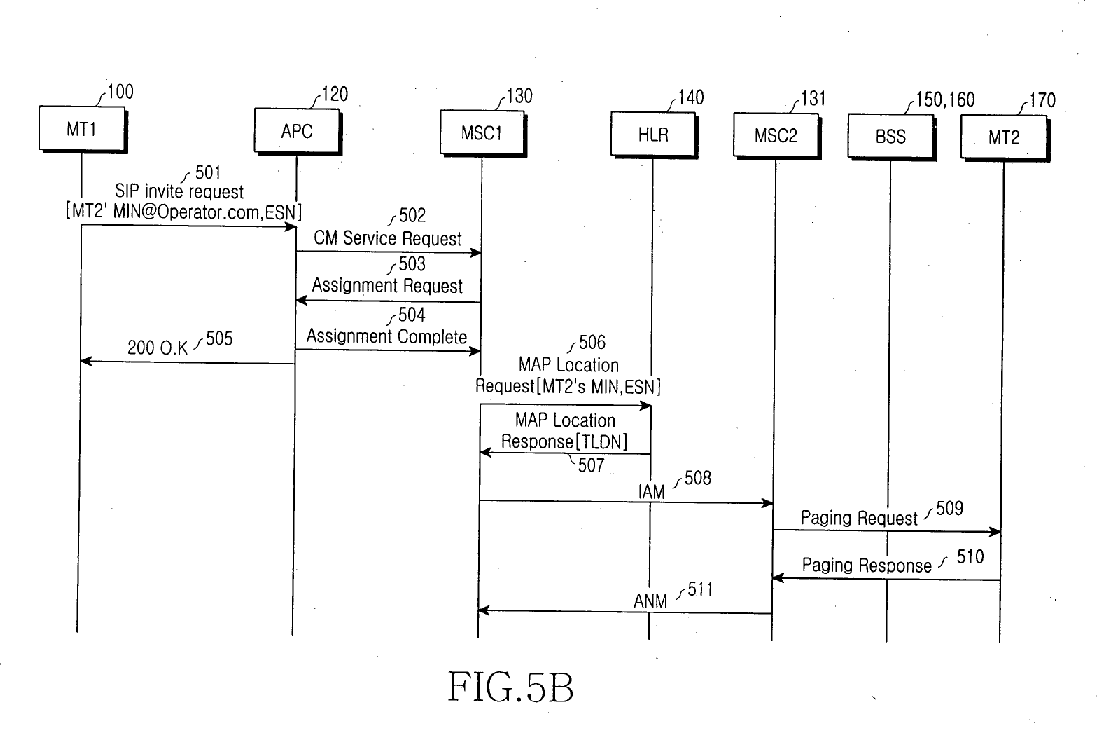

FIG. 5A is a network configuration diagram illustrating a call setup process from a wireless packet network to a mobile communication network according to an embodiment of the present invention, and FIG. 5B is a signaling diagram illustrating the call setup process. In the call setup process, a first mobile terminal MT1 100 in the wireless packet network transmits a voice call request to a second mobile terminal MT2 170 in the mobile communication network.

It is assumed for illustration purposes in FIG. 5A that the first mobile terminal MT1 100 is a calling terminal connected to the wireless packet network and the second mobile terminal MT2 170 is a called terminal connected to the mobile communication network. For convenience, in FIG. 5B, a BTS 160 and a BSC 150 are denoted by a base station system (BSS).

In step 501, the first mobile terminal MT1 100, a calling terminal, transmits a SIP Invite Request message including an MIN2 of the second mobile terminal MT2 170, a called terminal, and its own ESN to an APC 120 through an AP 110 to request call setup with the second mobile terminal MT2 170. Herein, the MIN2 is preferably transmitted in a URL form of, for example, MIN2@operator.com. The ESN is delivered to an HLR 140 for subscriber authentication.

Upon receiving the SIP Invite Request message, the APC 120 generates and transmits in step 502 a Connection Management (CM) Service Request message, which is an A1 message for voice call connection, to a first MSC 130. In step 503, the first MSC 130 transmits an Assignment Request message for CIC allocation for a voice path with the APC 120, to the APC 120. After completion of the CIC allocation with the first MSC 130, the APC 120 transmits an Assignment Complete message to the first MSC 130 in step 504, and transmits a 200 O.K message to the first mobile terminal MT1 100 in step 505.

In step 506, the first MSC 130 transmits a MAP Location Request message including an MIN2 and an ESN to the HLR 140, to detect a second MSC 131 in which the second mobile terminal MT2 170 is registered. In step 507, the HLR 140 determines whether the first mobile terminal MT1 100 is a registered terminal by analyzing the ESN, and then transmits a Temporary Local Directory Number (TLDN) indicating information on a location in which the second mobile terminal MT2 170 is registered, to the first MSC 130 using a MAP Location Response message, if it is determined that the first mobile terminal MT1 100 is a registered terminal.

Upon receiving the TLDN, the first MSC 130 transmits in step 508 an IAM message for voice call connection to the second MSC 131 detected based on the TLDN. In step 509, the second MSC 131 transmits a Paging Request message indicating the call arrival to the second mobile terminal MT2 170 through a BSS 150 and 160. Upon receiving the Paging Request message, the second mobile terminal MT2 170 transmits in step 510 a Paging Response message for approving the paging request to the second MSC 131 via the BSS 150 and 160. In step 511, the second MSC 131 transmits to the first MSC 130 an ANM message indicating completion of the voice call setup to the second mobile terminal MT2 170.

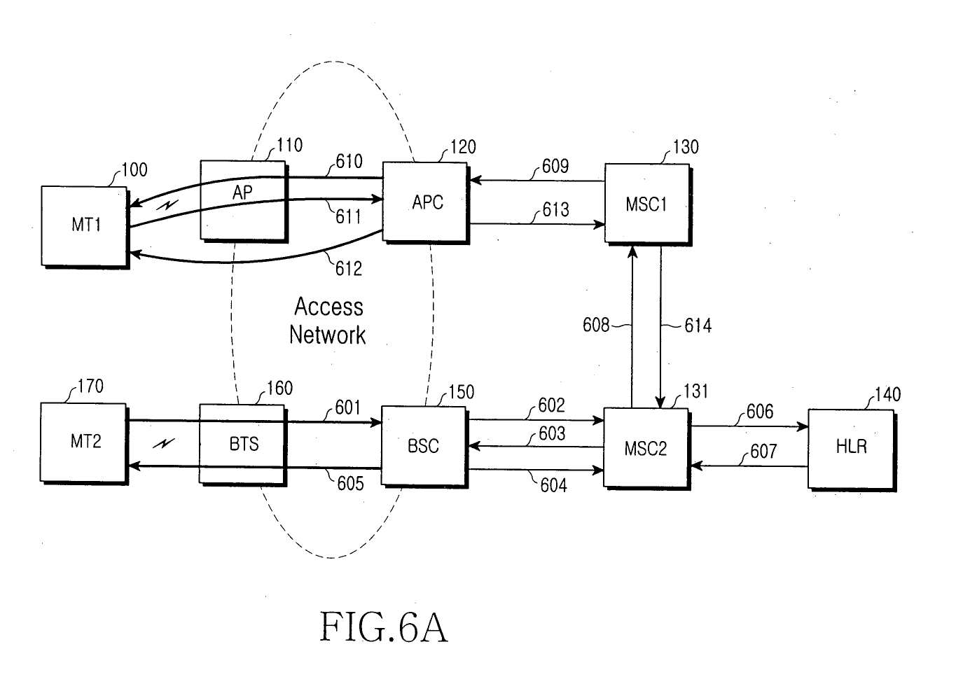

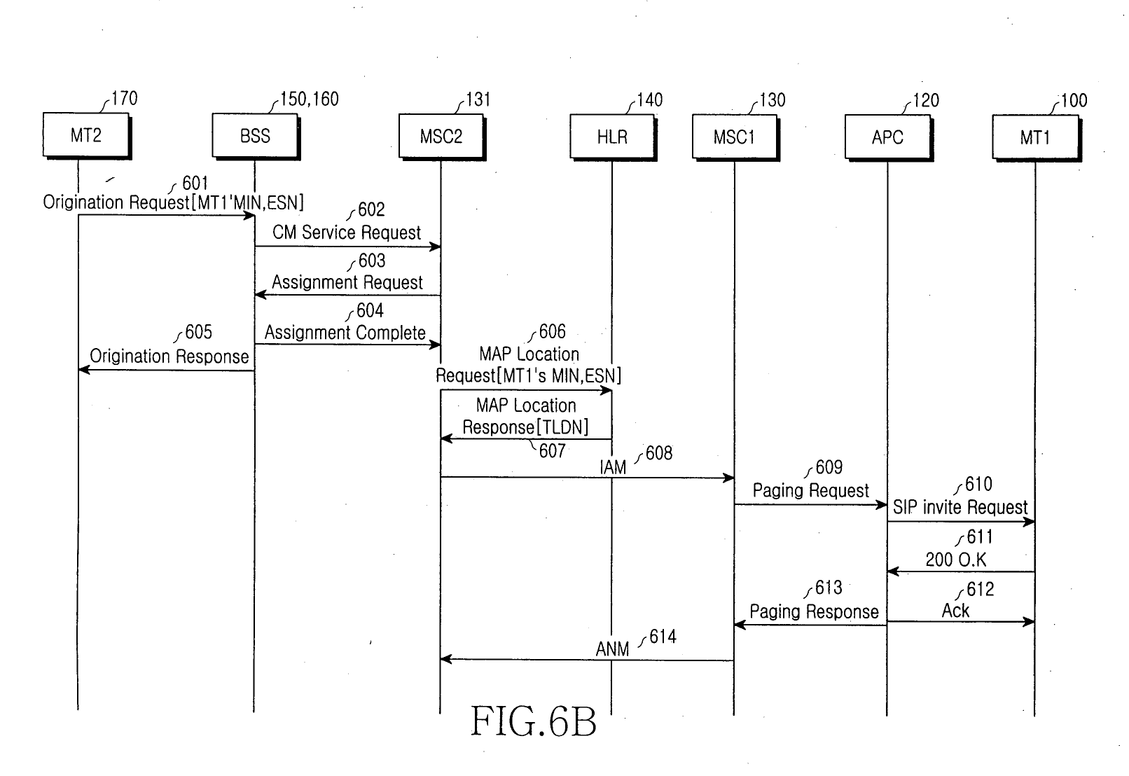

FIG. 6A is a network configuration diagram illustrating a call setup process from a mobile communication network to a wireless packet network according to an embodiment of the present invention, and FIG. 6B is a signaling diagram illustrating the call setup process. In the call setup process, a second mobile terminal MT2 170 in the mobile communication network transmits a voice call request to a first mobile terminal MT1 100 in the wireless packet network.

It is assumed for illustration purposes in FIG. 6A that the second mobile terminal MT2 170 is a calling terminal connected to the mobile communication network and the first mobile terminal MT1 100 is a called terminal connected to the wireless packet network. For convenience, in FIG. 6B, a BTS 160 and a BSC 150 are denoted by a BSS.

In step 601, the second mobile terminal MT2 170, a calling terminal, transmits an Origination Request message including an MIN1 of the first mobile terminal MT1 100, a called terminal, and its own ESN to a BSS 150 and 160 to request call setup with the first mobile terminal MT1 100. Herein, the MIN1 is preferably transmitted in a URL form of, for example, MIN1@operator.com. The ESN is transmitted to an HLR 140 for subscriber authentication. Upon receiving the Origination Request message, the BSS 150 and 160 generates and transmits in step 602 a CM Service Request message, which is an A1 message for voice call connection, to a second MSC 131, which is an MSC in the calling side. In step 603, the second MSC 131 transmits a MAP Assignment Request message for CIC allocation for a voice path with the BSS 150 and 160, to the BSS 150 and 160. Then the BSS 150 and 160 transmits a MAP Assignment Complete message to the second MSC 131 in step 604, and transmits an Origination Response message to the second mobile terminal MT2 170 in step 605. In step 606, the second MSC 131 transmits a MAP Location Request message including an MIN1 to the HLR 140 to detect a location of a first mobile station 100. In step 607, the HLR 140 delivers a TLDN indicating location information of the first mobile terminal MT1 100 to the second MSC 131 using a MAP Location Response message. Upon receiving the TLDN, the second MSC 131 transmits in step 608 an IAM message for voice call connection to the first MSC 130 detected based on the TLDN. In step 609, the first MSC 130 transmits a Paging Request message for requesting a paging to the first mobile terminal MT1 100, to an APC 120. Then the APC 120 transmits in step 610 a SIP Invite Request message indicating the call arrival to the first mobile terminal MT1 100.

Upon receiving the SIP Invite Request message, the first mobile terminal MT1 100 transmits in step 611 a SIP O.K message (or 200 O.K message) for approving the call connection, to the APC 120 via an AP 110. In step 612, the APC 120 transmits an acknowledgement (Ack) message to the first mobile terminal MT1 100 in response thereto. Thereafter, in step 613, the APC 120 transmits a Paging Response message to the first MSC 130 in response to the Paging Request message. In step 614, the first MSC 130 transmits an ANM message indicating completion of the voice call setup with the first mobile terminal MT1 100 to the second MSC 131, indicating the successful call setup.

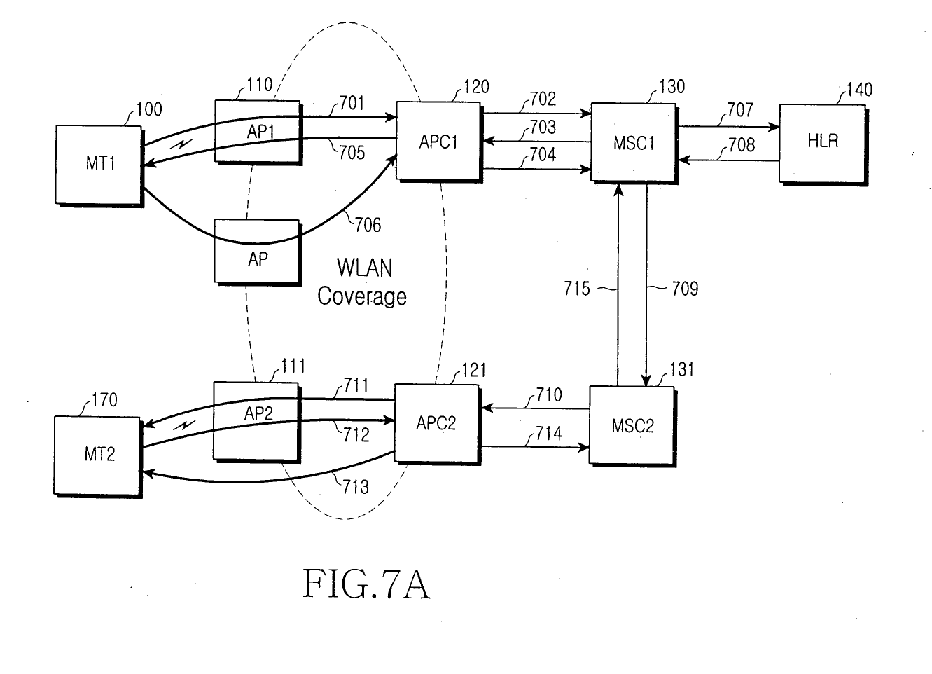

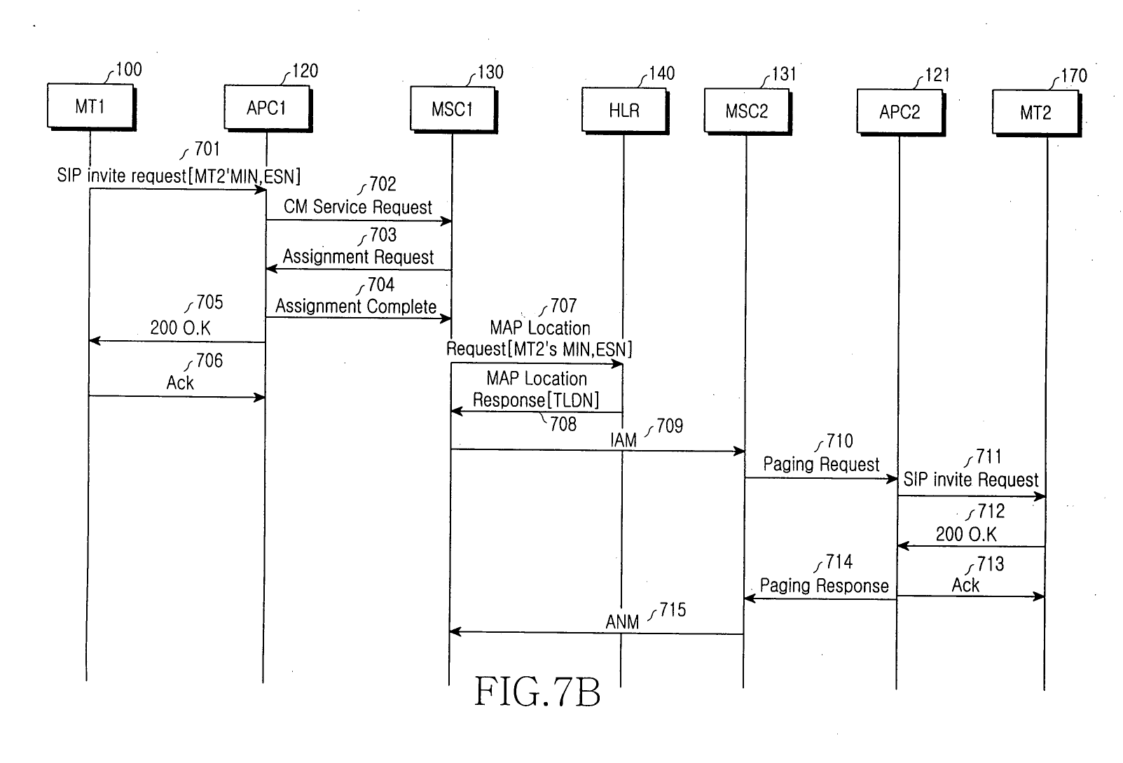

FIG. 7A is a network configuration diagram illustrating a call setup process between wireless packet networks belonging to different domains according to an embodiment of the present invention, and FIG. 7B is a signaling diagram illustrating the call setup process. In the call setup process, a first mobile terminal MT1 100 connected to a first wireless packet network transmits a voice call request to a second mobile terminal MT2 170 connected to a second wireless packet network.

In FIG. 7A, the first and second wireless packet networks comprise first and second APCs 120 and 121 for connecting/releasing a VoIP-based voice call, respectively, and the first and second APCs 120 and 121 both have the structure described in connection with FIG. 2.

In step 701, the first mobile terminal MT1 100, a calling terminal, transmits a SIP Invite Request message including an MIN2 of the second mobile terminal MT2 170, a called terminal, and its own ESN to a first APC 120, to request call setup with the second mobile terminal MT2 170. Herein; the MIN2 is preferably transmitted in a URL form of, for example, MIN2@operator.com. The ESN is transmitted to an HLR 140 for subscriber authentication.

Upon receiving the SIP Invite Request message, the first APC 120 transmits in step 702 a CM Service Request message to a first MSC 130, which is an MSC in the calling side. In step 703, the first MSC 130 transmits an Assignment Request message for CIC allocation for a voice path with the first APC 120, to the first APC 120. After completion of the CIC allocation with the first MSC 130, the first APC 120 transmits an Assignment Complete message to the first MSC 130 in step 704, and transmits a 200 O.K message to the first mobile terminal MT1 100 in step 705. Then the first mobile terminal MT1 100 transmits an Ack message to the first APC 120 in response thereto in step 706.

Thereafter, in step 707, the first MSC 130 transmits a MAP Location Request message including the MIN2 and the ESN to the HLR 140, to detect a second APC 121 in which the second mobile terminal MT2 170 is registered. In step 708, the HLR 140 determines whether the first mobile terminal MT1 100 is a registered terminal by analyzing the ESN, and then transmits a TLDN indicating information on a location in which the second mobile terminal MT2 170 is registered, to the first MSC 130 using a MAP Location Response message, if it is determined that the first mobile terminal MT1 100 is a registered terminal.

Upon receiving the TLDN, the first MSC 130 transmits in step 709 an IAM message for voice call connection to the second MSC 131 detected based on the TLDN. In step 710, the second MSC 131 transmits a Paging Request message for requesting a paging to the second mobile terminal MT2 170 to the second APC 121. The second MSC 131 knows in which APC the second mobile terminal MT2 170 is registered. Then the second APC 121 transmits a SIP Invite Request message indicating the call arrival to the second mobile terminal MT2 170 in step 711.

Upon receiving the SIP Invite Request message, the second mobile terminal MT2 170 transmits in step 712 a SIP O.K message (or 200 O.K message) for approving the call connection to the APC 121 via an AP 110. In step 713, the second APC 121 transmits an Ack message to the second mobile terminal MT2 170 in response thereto. Thereafter, in step 714, the second APC 121 transmits a Paging Response message to the second MSC 131 in response to the Paging Request message. In step 715, the second MSC 131 transmits an ANM message indicating the completion of the voice call setup to the first MSC 130, indicating the successful call setup to the second mobile terminal MT2 170. Therefore, the first mobile terminal MT1 100 and the second mobile terminal MT2 170 can perform voice communication with each other.

FIG. 8 is a block diagram illustrating an exemplary configuration of a network interworking system for providing SMS service between heterogeneous networks according to another embodiment of the present invention.

In FIG. 8, a first mobile terminal MT1 810 comprises a terminal that is capable of accessing a wireless packet network, and a second mobile terminal MT2 890 comprises a terminal that is capable of accessing a mobile communication network. A dual-mode terminal that is capable of accessing both the wireless packet network and the mobile communication network can be used as each of the first and second mobile terminals MT1 810 and MT2 890, as described in connection with FIG. 1. Herein, for convenience, the first and second mobile terminals MT1 810 and MT2 890 are divided into a first mobile terminal MT1 810 for accessing a wireless packet network and receiving packet service and/or SMS service from the wireless packet network, and a second mobile terminal MT2 890 for accessing a mobile communication network and receiving voice service and/or SMS service from the mobile communication network.

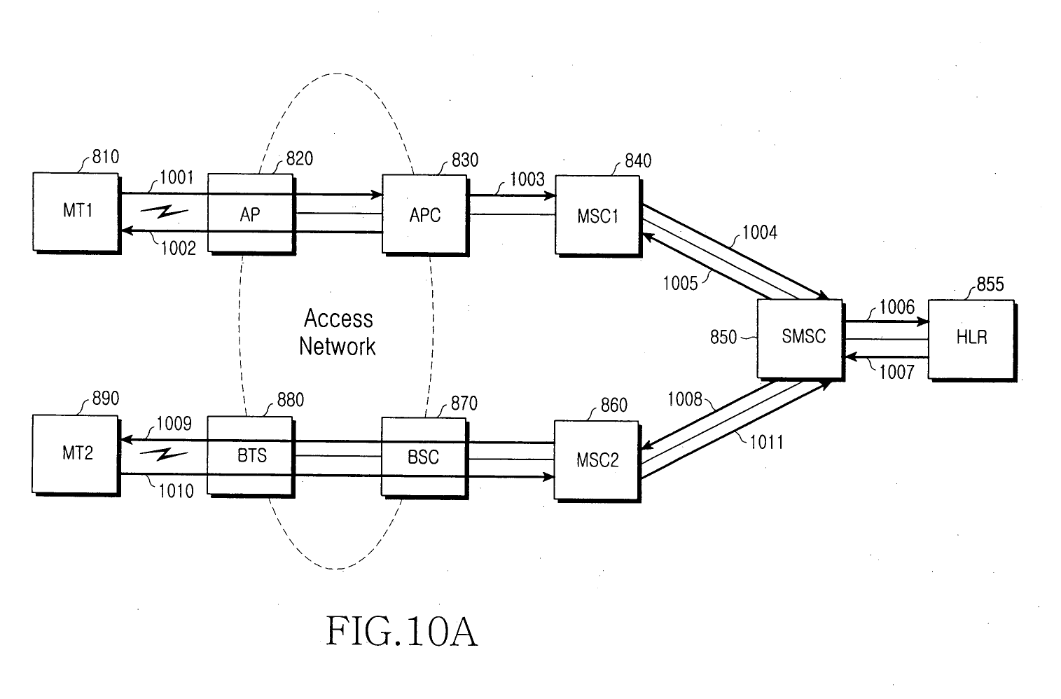

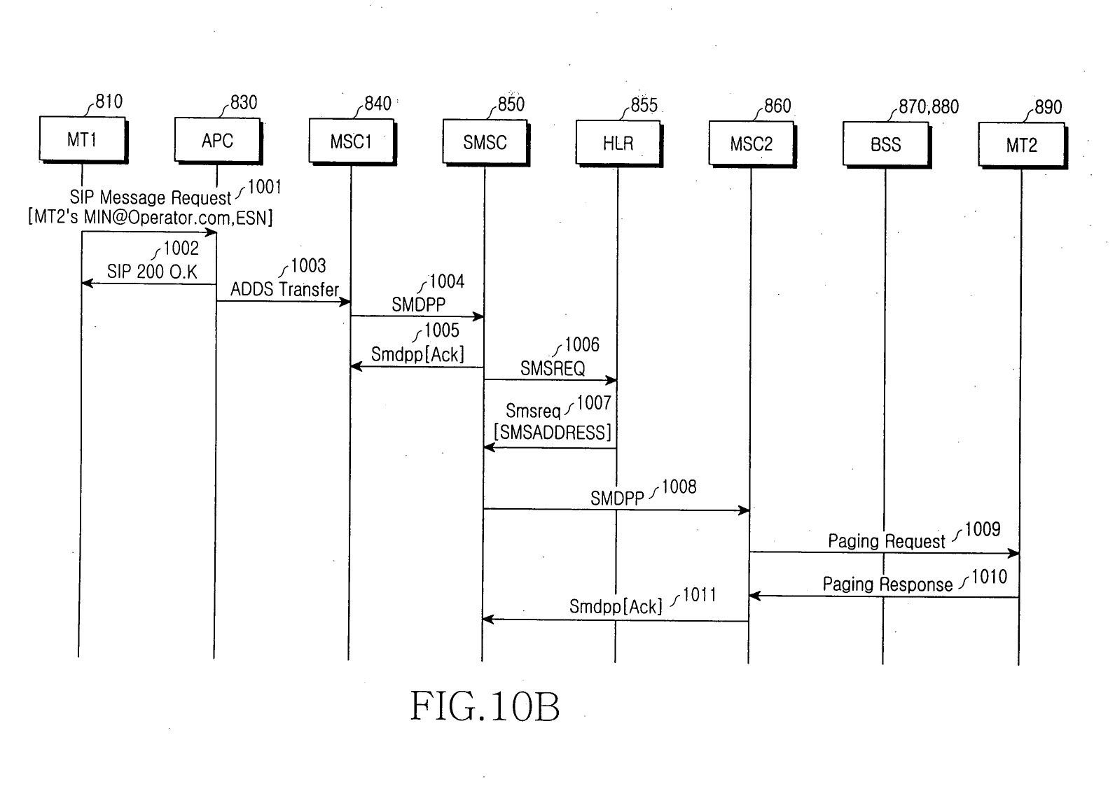

The wireless packet network of FIG. 8 can include any suitable wireless network such as a IEEE 802.1x or IEEE 802.2x-based WLAN or an IEEE 802.16e-based WiBro network, and comprises an APC 830, an MSC 840, and an SMS center (SMSC) 850 so as to provide not only IP-based packet service but also SMS service used in the mobile communication network to subscribers. The mobile communication network of FIG. 8 also comprises the MSC 840 and the SMSC 850 so as to provide not only the voice service but also SMS service to subscribers. Herein, the SMSC 850 is connected to an HLR 855 for detecting location information of the first and second mobile terminals MT1 810 and MT2 890. Although not illustrated in FIG. 8, both the SMSC 850 and the HLR 855 for location registration and location information detection for the mobile terminals MT1 810 and MT2 890 may be shared by the wireless packet network and the mobile communication network, as shown in FIGS. 10A, 11A and 12A. The first mobile terminal MT1 810 accesses the wireless packet network using a SIP. In an embodiment of the present invention, when transmitting an SMS message to the second mobile terminal MT2 890, which is a called terminal, the first mobile terminal MT1 810 that can access the wireless packet network using a SIP, transmits a MIN of the second mobile terminal MT2 890 in a SIP URL form of, for example, MIN@operator.com. The first mobile terminal MT1 810 can transmit a SIP Message Request message including a SIP URL and/or an IMSI of the called terminal to the APC 830 via an AP 820, together with a SMS message input by a user. In addition, when requesting origination of an SMS message, the first mobile terminal MT1 810 can transmit the SIP URL and its own ESN together. When there is an SMS message originated from the mobile communication network, the first mobile terminal MT1 810 receives a SIP Message Request message transmitted by the calling terminal, from the APC 830.

In the wireless packet network of FIG. 8, the first mobile terminal MT1 810 accesses the wireless packet network via an AP 820 for connecting a wireless network to a wire network and an APC 830 for controlling packet communication, and receives SMS service as well as packet service. The APC 830 including a SIP-based gateway connected to the first mobile terminal MT1 810 supporting the SMS service, accesses the SMSC 850 for repeating SMS message transmission, and handles transmission/reception of SMS messages to/from another mobile terminal in the wireless packet network or the second mobile terminal MT2 890 in the mobile communication network.

The APC 830 performs interworking with the MSC 840 using an A1/A2 interface and an SS7 protocol to deliver an SMS message. To this end, the APC 830 performs data conversion for interworking between the mobile communication network and the wireless packet network through transmission/reception of a SIP message and Application Data Delivery Service (ADDS) Transfer message which is an A1 message. Herein, the term “SMS delivery message” has the same meaning as the term “ADDS Transfer message.” The APC 830 includes a signaling gateway (SGW) 830 for handling transmission of SIP messages for subscriber's SMS service, and a media gateway (MGW) 835 for connecting/disconnecting a bearer for subscriber's traffic transmission. The APC 830 will be described in greater detail below.

The MSC 840 performs communication with the SMSC 850 using, for example, an Interim Standard-41 Mobile Application Part (IS-41 MAP). Upon receiving a request for transmission of an SMS message from the first mobile terminal MT1 810, the MSC 840 transmits an IS-41 MAP-based SMS Delivery Point to Point (SMDPP) message for requesting transmission of an SMS message to the SMSC 850 along with the corresponding SMS message. Herein, the term “delivery message” has the same meaning as the term “SMDPP message.”

Upon receiving a request for transmission of an SMS message to the first mobile terminal MT1 810 from the second mobile terminal MT2 890 connected to the mobile communication network, the MSC 840 receives an IS-41 MAP-based SMDPP message for requesting transmission of an SMS message together with a corresponding SMS message, and transmits a SIP Message Request message including a SIP URL and an ESN to the first mobile terminal MT1 810. If the first mobile terminal MT1 810 responds to the SIP Message Request message, the MSC 840 transmits the SMS message delivered from the SMSC 850 to the first mobile terminal MT1 810.

For the foregoing exemplary operation, the MSC 840 comprises a VLR (not shown) for storing a subscriber profile delivered from the HLR 855 during location registration for the first and second mobile terminals MT1 810 and MT2 890.

A location registration/deregistration process for the first mobile terminal MT1 810 connected to the wireless packet network is performed in the process described with reference to FIGS. 3A, 3B, 4A and 4B, and because a location registration/deregistration process for the second mobile terminal MT2 890 connected to the mobile communication network is well known to those skilled in the art, a detailed description thereof will be omitted herein for simplicity.

In FIG. 8, the second mobile terminal MT2 890 accesses the mobile communication network through a BTS 880 and a BSC 870 for controlling the BTS 880, and receives SMS service as well as the general circuit-switched voice service. The MSC 840, to which the second mobile terminal MT2 890 using the SMS service is connected, accesses the SMSC 850 for repeating SMS message transmission, and handles transmission/reception of SMS messages to/from another mobile terminal in the mobile communication network or the first mobile terminal MT1 810 in the wireless packet network.

In the case of a first MSC 840 shown in FIG. 10A, upon receiving an ADDS Transfer message in which an origination request to the second mobile terminal MT2 890 is taken into consideration, from the first mobile terminal MT1 810 along with an SMS message, the first MSC 840 transmits an SMDPP message for requesting transmission of an SMS message to the SMSC 850.

When transmitting an SMS message of the first mobile terminal MT1 810, a second MSC 860 shown in FIG. 10A receives an SMDPP message for requesting transmission of an SMS message from the SMSC 850, and transmits a Paging Request message to the second mobile terminal MT2 890 which his a called terminal. Thereafter, if the second mobile terminal MT2 890 responds to the paging request, the second MSC 860 transmits the SMS message delivered from the SMSC 850 to the second mobile terminal MT2 890.

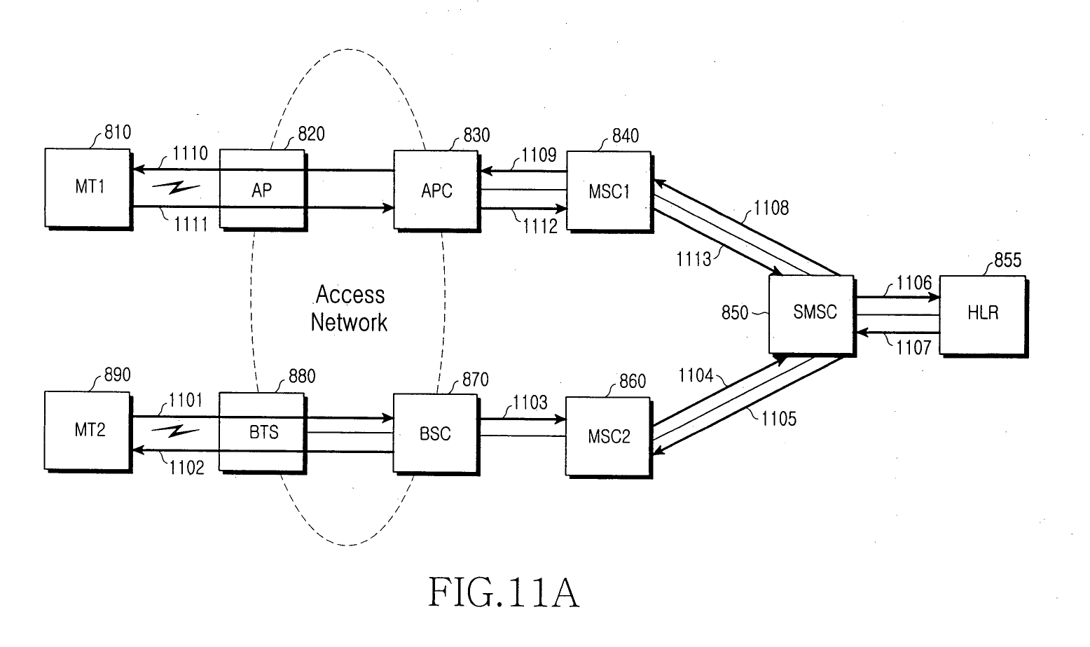

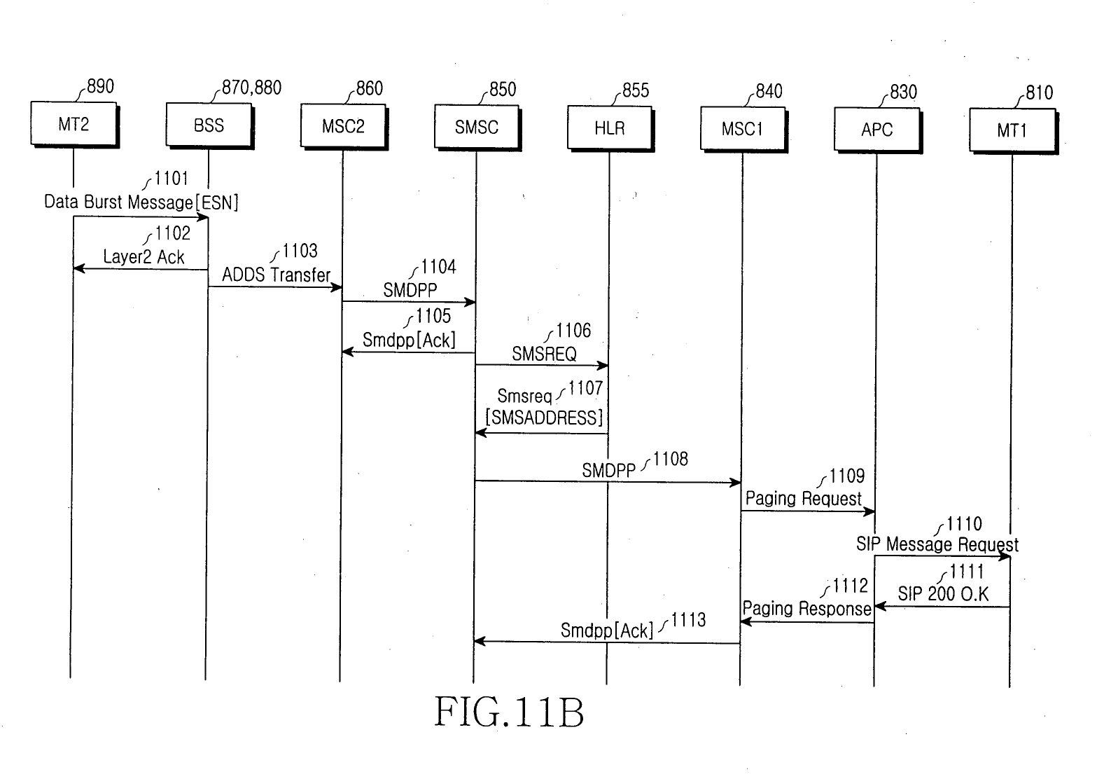

In the case of a second MSC 860 shown in FIG. 11A, upon receiving an Origination Request message for the first mobile terminal MT1 810 along with an SMS message from the second mobile terminal MT2 890, the second MSC 860 transmits an SMDPP message for requesting SMS message transmission to the SMSC 850. When transmitting an SMS message of the second mobile terminal MT2 890, a first MSC 840 shown in FIG. 11A receives an SMDPP message for requesting transmission of an SMS message from the SMSC 850 and transmits a Paging Request message to the first mobile terminal 810 which is a called terminal. Thereafter, if the first mobile terminal MT1 100 responds to the paging request, the first MSC 840 transmits the SMS message delivered from the SMSC 850 to the first mobile terminal MT1 810.

In an exemplary embodiment of the present invention, the SMSC 850 for repeating SMS message transmission between the wireless packet network and the mobile communication network and SMS message transmission between wireless packet networks belonging to different domains, receives address information of the second MSC 860 in which a called terminal is located, or the first MSC 840 in which a calling terminal is located, from an HLR 855, and transmits an SMS message to the called terminal belonging to the first MSC 840 or the second MSC 860. The SMSC 850 transmits a MIN using the SIP Message Request message and the Origination Request message so that the HLR 855 can acquire address information of the called terminal.

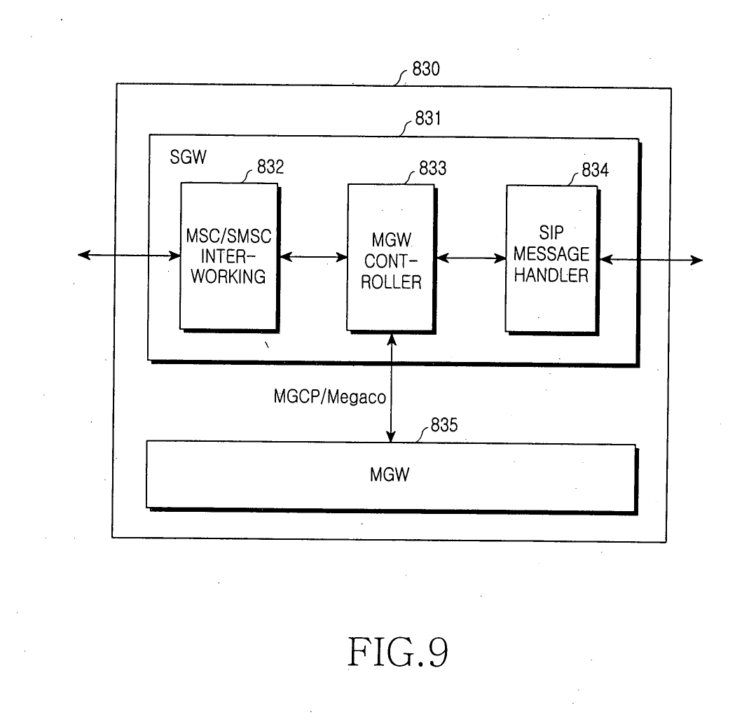

With reference to FIG. 9, a detailed description will now be made of the APC 830.

FIG. 9 is a block diagram illustrating a structure of the APC 830 shown in FIG. 8. The APC 830 comprises an SGW 831 for handling transmission of SMS messages and transmission of SIP messages for subscriber's call setup/release, and an MGW 835, connected to the SGW 831 via a MGCP/MEGACO, well known to those skilled in the art as a gateway control protocol, for performing data conversion (or data interpretation) between the mobile communication network and the wireless packet network.

The SGW 831 comprises an MSC/SMSC interworking unit 832, an MGW controller 833 and a SIP message handler 834.

The MSC/SMSC interworking unit 832 performs tightly interworking with an MSC 840 using an A1/A2 interface to provide SMS service supported in the mobile communication network to a subscriber of the wireless packet network.

The SIP message handler 834 handles SIP messages used for SMS message delivery and call connection/disconnection.

Upon receiving a call connection or disconnection signal from the SIP message handler 834 or the MSC/SMSC interworking unit 832, the MGW controller 833 exchanges control signals for connecting or disconnecting a bearer with the MGW 835.

For SMS message delivery from the wireless packet network to the mobile communication network, shown in FIG. 10A, upon receiving information indicating receipt of a SIP Message Request message including a MIN of a called terminal from the SIP message handler 834, the MSC/SMSC interworking unit 832 transmits an ADDS Transfer message to the MSC 840 to request SMS message transmission to the called terminal. For SMS message delivery from the mobile communication network to the wireless packet network, shown in FIG. 11A, upon receiving a Paging Request message from the MSC 840, the MSC/SMSC interworking unit 832 transmits a SIP Message Request message to the corresponding called terminal via the SIP message handler 834, indicating the transmission of an SMS message.

With reference to FIGS. 10 through 12, a detailed description will now be made of an exemplary SMS message transmission/reception operation between a wireless packet network and a mobile communication network, and an exemplary SMS message transmission/reception operation between wireless packet networks, both of the operations being performed through the network interworking system according to an embodiment of the present invention. In the drawings, the same or similar elements are denoted by the same reference numerals even though they are depicted in different drawings. In FIGS. 10 through 12, an access network comprises both a wireless packet network and a mobile communication network, to each of which a mobile terminal is connected.

FIG. 10A is a network configuration diagram illustrating an SMS message transmission process from a wireless packet network to a mobile communication network according to an embodiment of the present invention, and FIG. 10B is a signaling diagram illustrating the SMS message transmission process. In the SMS message transmission process, a first mobile terminal MT1 810 in the wireless packet network transmits a request for transmission of an SMS message to a second mobile terminal MT2 890 in the mobile communication network. In addition, it will be assumed for illustration purposes that an HLR 855 registers therein a subscriber profile including location information of the first and second mobile terminals MT1 810 and MT2 890.

It is assumed for illustration purposes in FIG. 10A that the first mobile terminal MT1 810 is a calling terminal connected to the wireless packet network and the second mobile terminal MT2 890 is a called terminal connected to the mobile communication network. For convenience, in FIG. 10B, a BTS 880 and a BSC 870 are denoted by a BSS.

In step 1001, the first mobile terminal MT1 810, a calling terminal, transmits a SIP Message Request message including an MIN of the second mobile terminal MT2 890, a called terminal, and its own ESN along with an SMS message input by a user to an APC 830 via an AP 820 to request transmission of an SMS message to the second mobile terminal MT2 890. Herein, the MIN is preferably transmitted in a SIP URL form of, for example, MIN@operator.com.

Upon receiving the SIP Message Request message, the APC 830 transmits in step 1002 a SIP O.K message (or SIP 200 O.K message) indicating the successful transmission of the SMS message, to the first mobile terminal MT1 810. Thereafter, in step 1003, the APC 830 transmits an ADDS Transfer message, or an A1 message, for delivery of an SMS message to a first MSC 840, which is an MSC in the calling side. Then the first MSC 840 transmits in step 1004 an SMDPP message for requesting SMS message transmission to the second mobile terminal MT2 890 to the SMSC 850 along with a corresponding SMS message, using an IS-41 MAP. Upon receiving the SMDPP message, the SMSC 850 transmits in step 1005 an smdpp message indicating the successful receipt of the SMDPP message to the first MSC 840.

Upon receiving the SMDPP message, the SMSC 850 transmits in step 1006 an SMS Request (SMSREQ) message including, for example, a MIN of the second mobile terminal MT2 890 to an HLR 855, so that the HLR 855 can refer to a second MSC 860 in which the called terminal is registered. In step 1007, the HLR 855 delivers an SMS Response (smsreq[SMSADDRESS]) message including location (address) information of the second MSC 860 in which the second mobile terminal MT2 890 is registered, that is, location information of the second mobile terminal MT2 890, to the SMSC 850.

Although not illustrated in FIG. 10B, the calling terminal's ESN delivered to the APC 830 in step 1001 is delivered to the HLR 855 through the ADDS Transfer message in step 1003 and the SMSREQ message in step 1006, and the HLR 855 determines whether the calling terminal is a registered terminal by analyzing the ESN, and delivers location information of the called terminal to the SMSC 850 in step 1007 if it is determined that the calling terminal is a registered terminal.

Upon detecting the location information of the second mobile terminal MT2 890, the SMSC 850 transmits in step 1008 an SMDPP message including the SMS message and an MIN of the second mobile terminal MT2 890 to the second MSC 860. In step 1009, the second MSC 860 detects a location of the second mobile terminal MT2 890 corresponding to the MIN by referring to an internal VLR (not shown), and then transmits a Paging Request message for SMS message transmission to the second mobile terminal MT2 890 via a BSS 870 and 880. In step 1010, the second mobile terminal MT2 890 transmits a Paging Response message to the second MSC 860 to receive the SMS message from the first mobile terminal MT1 810. Then the second MSC 860 transmits an smdpp[Ack] message indicating the successful receipt to the SMSC 850 in step 1011.

FIG. 11A is a network configuration diagram illustrating an SMS message transmission process from a mobile communication network to a wireless packet network according to another embodiment of the present invention, and FIG. 11B is a signaling diagram illustrating the SMS message transmission process. In the SMS message transmission process, a second mobile terminal MT2 890 in the mobile communication network transmits a request for transmission of an SMS message to a first mobile terminal MT1 810 in the wireless packet network. In addition, it will be assumed for illustration purposes that an HLR 855 registers therein a subscriber profile including location information of the first and second mobile terminals MT1 810 and MT2 890.

It is assumed for illustration purposes in FIG. 11A that the second mobile terminal MT2 890 is a calling terminal connected to the mobile communication network and the first mobile terminal MT1 810 is a called terminal connected to the wireless packet network. For convenience, in FIG. 1B, a BTS 880 and a BSC 870 are denoted by a BSS.

In step 1101, the second mobile terminal MT2 890, a calling terminal, transmits an Origination Request[SMD-Request] message including an MIN of the first mobile terminal MT1 810, a called terminal, and its own ESN along with an SMS message input by a user to a BSS 870 and 880 using a Data Burst message, to request transmission of an SMS message to the first mobile terminal MT1 810. Upon receiving the Origination Request[SMD-Request] message, the BSS 870 and 880 transmits a Layer 2 Ack message to the second mobile terminal MT2 890 in step 1002.

Thereafter, in step 1003, the BSS 870 and 880 transmits an ADDS Transfer message, which is an A1 message for delivery of an SMS message, to a second MSC 860, which is an MSC in the calling terminal. In step 1104, the second MSC 860 transmits an SMDPP message for requesting SMS message transmission to first mobile terminal MT1 810 along with the corresponding SMS message to an SMSC 850 using an IS-41 MAP. Upon receiving the SMDPP message, the SMSC 850 transmits an smdpp message indicating the successful receipt to the second MSC 860 in step 1105.

Upon receiving the SMDPP message, the SMSC 850 transmits in step 1106 an SMS Request (SMSREQ) message including, for example, a MIN of the first mobile terminal MT1 810 to an HLR 855, so that the HLR 855 can refer to a first MSC 840 in which the called terminal is registered. In step 1107, the HLR 855 transmits an SMS Response (smsreq[SMSADDRESS]) message including location (address) information of the first MSC 840 in which the first mobile terminal MT1 810 is registered, that is, location information of the first mobile terminal MT1 810, to the SMSC 850.

Although not illustrated in FIG. 11B, the calling terminal's ESN delivered to the BSS 870 and 880 in step 1101 is delivered to the HLR 855 through the ADDS Transfer message in step 1103, the SMDPP message in step 1104 and the SMSREQ message in step 1106, and the HLR 855 determines whether the calling terminal is a registered terminal by analyzing the ESN, and delivers location information of the called terminal to the SMSC 850 in step 1107 if it is determined that the calling terminal is a registered terminal.

Upon detecting the location information of the first mobile terminal MT1 810, the SMSC 850 transmits in step 1108 an SMDPP message including the SMS message and an MIN of the first mobile terminal MT1 810 to the first MSC 840. In step 1109, the first MSC 840 detects a location of the first mobile terminal MT1 810 corresponding to the MIN by referring to an internal VLR, and then transmits a Paging Request message for SMS message transmission to the first mobile terminal MT1 810 to an APC 830. In step 1110, the APC 830 transmits a SIP Message Request message for requesting SMS message transmission to the first mobile terminal MT1 810. In step 1111, the first mobile terminal MT1 810 transmits a SIP O.K message (or SIP 200 O.K message) to the APC 830 to receive the SMS message from the second mobile terminal MT2 890. Thereafter, the APC 830 transmits a Paging Response message to the first MSC 840 in step 1112, and the first MSC 840 transmits an smdpp message indicating the successful transmission of the SMS message to the SMSC 850 in step 1113.

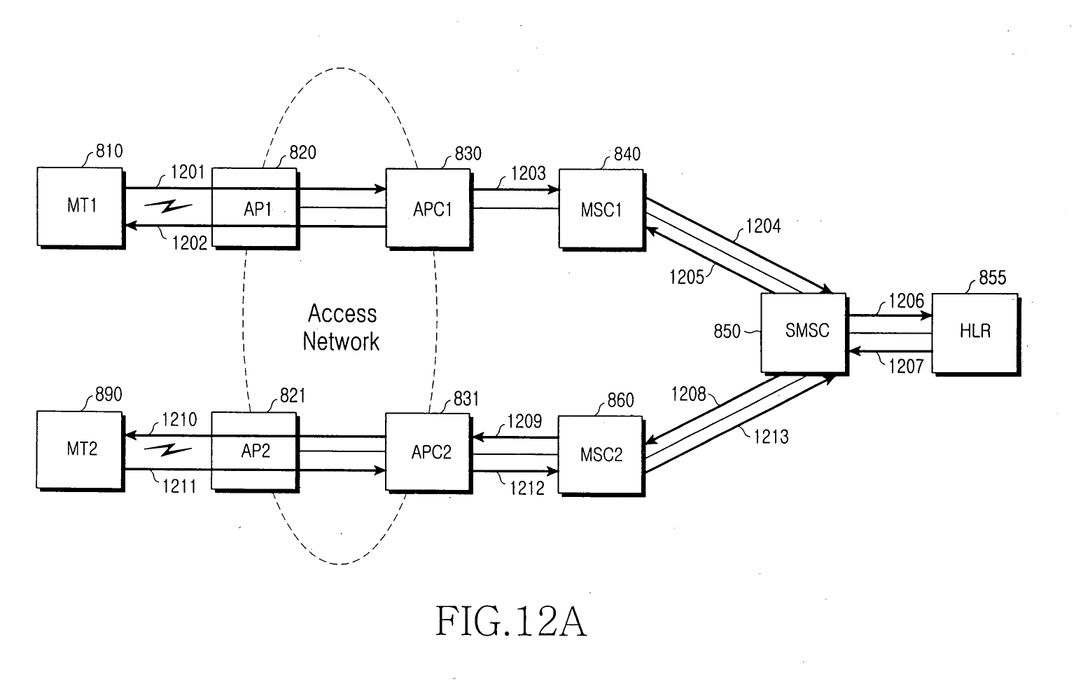

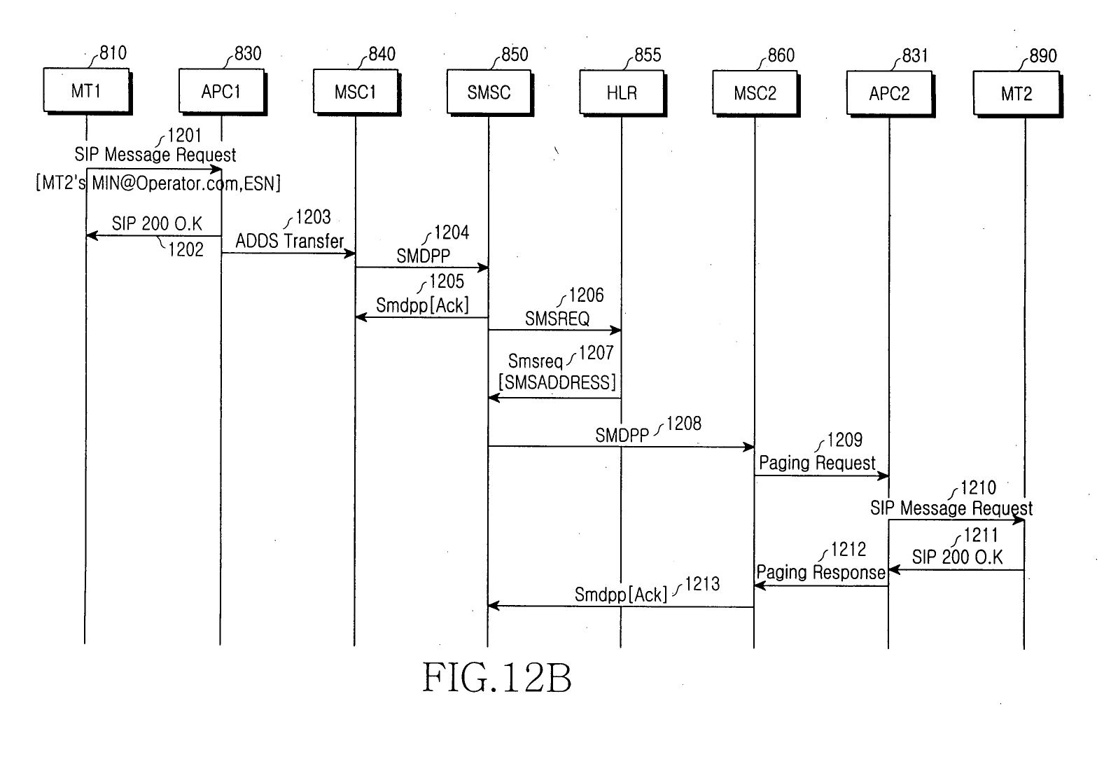

FIG. 12A is a network configuration diagram illustrating an SMS message transmission process between wireless packet networks belonging to different domains according to another embodiment of the present invention, and FIG. 12B is a signaling diagram illustrating the SMS message transmission process. In the SMS message transmission process, a first mobile terminal MT1 810 connected to a first wireless packet network transmits a request for transmission of an SMS message to a second mobile terminal MT2 890 connected to a second wireless packet network. In addition, it will be assumed for illustration purposes that an HLR 855 registers therein a subscriber profile including location information of the first and second mobile terminals MT1 810 and MT2 890.

In FIG. 12A, the first and second wireless packet networks individually provide packet services and include first and second APCs 830 and 831 for handling SMS message transmission by interworking with an SMSC 850, respectively, and the first and second APCs 830 and 831 both have the structure described in connection with FIG. 9.

In step 1201, the first mobile terminal MT1 810, a calling terminal, transmits a SIP Message Request message including an MIN2 of the second mobile terminal MT2 890, a called terminal, and its own ESN along with an SMS message input by a user to a first APC 830, an APC in the calling side, through an AP 820 to request transmission of an SMS message to the second mobile terminal MT2 890, which is a called terminal. Herein, the MIN2 is preferably transmitted in a URL form of, for example, MIN2@operator.com.

Upon receiving the SIP Message Request message, the first APC 830 transmits in step 1202 a SIP O.K message (or SIP 200 O.K message) indicating the successful transmission of the SMS message to the first mobile terminal MT1 810. Thereafter, in step 1203, the first APC 830 transmits an ADDS Transfer message, which is an A1 message for SMS message delivery, to a first MSC 840. Then the first MSC 840 transmits in step 1204 an SMDPP message for requesting SMS message transmission to the second mobile terminal MT2 890 along with a corresponding SMS message to the SMSC 850 using an IS-41 MAP. Upon receiving the SMDPP message, the SMSC 850 transmits in step 1205 an smdpp[Ack] message indicating the successful receipt to the first MSC 840.

Upon receiving the SMDPP message, the SMSC 850 transmits in step 1206 an SMS Request (SMSREQ) message including, for example, a MIN of the second mobile terminal MT2 890 to an HLR 855, so that the HLR 855 can refer to a second MSC 860 in which the second mobile terminal MT2 890 is registered. In step 1207, the HLR 855 delivers an SMS Response (smsreq[SMSADDRESS] message including location (address) information of the second MSC 860 in which the second mobile terminal MT2 890 is registered, i.e., location information of the second mobile terminal MT2 890, to the SMSC 850.

Although the ESN of the calling terminal being delivered to the first APC 830 in step 1201 is not illustrated in FIG. 12B, it is delivered to the HLR 855 through the ADDS Transfer message in step 1203, the SMDPP message in step 1204 and the SMSREQ message in step 1206, and the HLR 855 determines whether the calling terminal is a registered terminal by analyzing the ESN and delivers location information of the called terminal to the SMSC 850 in step 1207 if it is determined that the calling terminal is a registered terminal.

Upon detecting the location information of the second mobile terminal MT2 890, the SMSC 850 transmits in step 1208 an SMDPP message including the SMS message and an MIN of the second mobile terminal MT2 890 to the second MSC 860. In step 1209, the second MSC 860 detects a location of the second mobile terminal MT2 890 corresponding to the MIN by referring to an internal VLR (not shown), and transmits a Paging Request message for requesting SMS message transmission to the second APC 831. In step 1210, the second APC 831 transmits a SIP Message Request message for SMS message transmission to the second mobile terminal MT2 890. In step 12 11, the second mobile terminal MT2 890 transmits a SIP O.K message (or SIP 200 O.K message) to the second APC 831, to receive the SMS message from the first mobile terminal MT1 810. Thereafter, the second APC 831 transmits a Paging Response message to the second MSC 860 in step 1212, and the second MSC 860 transmits an smdpp[Ack] message indicating the successful receipt to the SMSC 850 in step 1213.

Although not illustrated in FIG. 12B, if the second mobile terminal MT2 890, a called terminal, is powered Off or if the second mobile terminal MT2 890 is located in a blanket area where it cannot receive SMS messages, the second mobile terminal MT2 890 cannot transmit the SIP O.K message (or SIP 200 O.K message) in step 1211. In this case, it is preferable that after detecting the SMS reception failure of the second mobile terminal MT2 890 through the second MSC 860, the SMSC 850 periodically repeats transmission of the SMS message until the second mobile terminal MT2 890 successfully receives the SMS message.

As can be understood from the foregoing description, embodiments of the present invention can guarantee seamless voice service between a mobile terminal connected to a mobile communication network and a mobile terminal connected to a wireless packet network, and can easily and effectively perform voice call connection from the mobile communication network to the wireless packet network, or voice call connection from the wireless packet network to the mobile communication network.

In addition, embodiments of the present invention can provide a location registration/deregistration process for a subscriber in a communication system in which the wireless packet network interworks with the mobile communication network, thereby contributing to popularization of SIP-based VoIP service. Further, embodiments of the present invention can provide wire/wireless integrated voice and additional services by linking circuit-switched voice service with VoIP-based service.

Moreover, embodiments of the present invention can substantially guarantee SMS service interworking between a mobile terminal connected to a mobile communication network and a mobile terminal connected to a wireless packet network, and can easily and effectively perform SMS message transmission from the mobile communication network to the wireless packet network, or SMS message transmission from the wireless packet network to the mobile communication network.

Further, embodiments of the present invention can provide the SMS service used in the mobile communication network even between wireless packet networks, and provide retransmission service unlike the general packet service, when a called terminal cannot receive signals.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A network interworking system for connecting a voice call from a calling terminal in a wireless packet network that provides voice over Internet protocol (VoIP) service to a called terminal in a mobile communication network that provides circuit-switched voice service, the system comprising:
a home location register (HLR) for registering therein location information of terminals and a subscriber profile;
an access point controller (APC) including a gateway for connection with the mobile communication network, for converting data between the mobile communication network and the wireless packet network using the gateway upon receipt of an origination message including a terminal identifier of a called terminal, and transmitting a call connection request to the called terminal;
a mobile switching center (MSC) for detecting a location of the called terminal through the HLR upon receipt of the call connection request to the called terminal from the APC, and transmitting a paging message to the detected location of the called terminal; and
a base station system (BSS) for transmitting the paging message from the MSC in the mobile communication network to the called terminal.

2. The network interworking system of claim 1, wherein:
the terminal identifier comprises a mobile identification number (MIN); and
the origination message comprises a session initiation protocol (SIP) invite request message generated by representing the terminal identifier in the form of a SIP uniform resource locator (URL).

3. The network interworking system of claim 1, wherein the origination message further comprises:
an electronic serial number (ESN) of the calling terminal, and the HLR is configured to determine whether the calling terminal is a registered terminal by analyzing the ESN included in the origination message and provide location information of the called terminal to the MSC if the calling terminal is a registered terminal.

4. The network interworking system of claim 1, wherein the HLR is configured to deliver location information of the called terminal to the MSC using an interim standard-41 mobile application part (IS-41 MAP) message.

5. The network interworking system of claim 1, wherein the calling terminal and the called terminal comprise dual-mode terminals, each of which is configured to access both the mobile communication network and the wireless packet network.

6. The wireless interworking system of claim 1, wherein the wireless packet network is located in an area of the mobile communication network.

7. The wireless interworking system of claim 1, wherein the APC comprises:
a signaling gateway comprising:
a SIP message handler for handling transmission/reception of SIP-based messages for voice call connection with the calling terminal and the called terminal; and
an MSC interworking unit for exchanging a message including call setup information between the calling terminal and the called terminal, with the MSC; and
a media gateway connected to the signaling gateway via a predetermined control protocol, for performing data conversion between the wireless packet network and the mobile communication network.

8. The network interworking system of claim 7, wherein the APC communicates with the MSC through an A1/A2 interface.

9. The network interworking system of claim 1, wherein the MSC is configured to transmit an initial address message (IAM) message including call setup information for call connection between the calling terminal and the called terminal to the MSC in the mobile communication network when a message including call setup information is received from the APC after completion of circuit identity code (CIC) allocation and a location of the called terminal is detected from the received message.

10. A network interworking system for connecting a voice call from a calling terminal in a mobile communication network that provides circuit-switched voice service to a called terminal in a wireless packet network that provides voice over Internet protocol (VoIP) service, the system comprising:
a home location register (HLR) for registering therein location information of terminals and a subscriber profile;
a base station system (BSS) for receiving an origination message including a terminal identifier of the called terminal from the calling terminal, and delivering the received origination message to a mobile switching center (MSC);
the MSC for transmitting a call connection request to a location of the called terminal, detected through the HLR, upon receiving the origination message; and
an access point controller (APC) including a gateway for connection with the mobile communication network, for converting data between the mobile communication network and the wireless packet network using the gateway upon receipt of the call connection request to the called terminal from the MSC, and transmitting a termination message for the voice call connection to the called terminal.

11. The network interworking system of claim 10, wherein the terminal identifier comprises a mobile identification number (MIN).

12. The network interworking system of claim 10, wherein the origination message comprises:
a session initiation protocol (SIP) invite request message.

13. The network interworking system of claim 10, wherein the origination message further comprises:
an electronic serial number (ESN) of the calling terminal, and the HLR is configured to determine whether the calling terminal is a registered terminal by analyzing the ESN included in the origination message and provide location information of the called terminal to the MSC if the calling terminal is a registered terminal.

14. The network interworking system of claim 10, wherein the HLR is configured to deliver location information of the called terminal to the MSC using an interim standard-41 mobile application part (IS-41 MAP) message.

15. The network interworking system of claim 10, wherein the calling terminal and the called terminal comprise dual-mode terminals, each of which is configured to access both the mobile communication network and the wireless packet network.

16. The network interworking system of claim 10, wherein the wireless packet network is located in an area of the mobile communication network.

17. The wireless interworking system of claim 10, wherein the APC comprises:
a signaling gateway comprising:
a SIP message handler for handling transmission/reception of SIP-based messages for voice call connection with the calling terminal and the called terminal; and
an MSC interworking unit for exchanging a message including call setup information between the calling terminal and the called terminal, with the MSC; and
a media gateway connected to the signaling gateway via a predetermined control protocol, for performing data conversion between the wireless packet network and the mobile communication network.

18. The wireless interworking system of claim 10, wherein the APC communicates with the MSC through an A1/A2 interface.

19. The network interworking system of claim 11, wherein the MSC is configured to transmit an initial address message (IAM) message including call setup information for call connection between the calling terminal and the called terminal to the MSC in the wireless packet network when a message including call setup information is received from the BSS after completion of circuit identity code (CIC) allocation and a location of the called terminal is detected from the received message.

20. A network interworking system for connecting a voice call from a calling terminal in a first wireless packet network to a called terminal in a second wireless packet network, each of the first and second wireless packet networks providing voice over Internet protocol (VoIP) service, the system comprising:
a home location register (HLR) for registering therein location information of terminals and a subscriber profile;
a first access point controller (APC) including a gateway for connection with the first wireless packet network, for converting data between the first and second wireless packet networks using the gateway upon receipt of an origination message including a terminal identifier of the called terminal;
a first mobile switching center (MSC) for detecting a location of the called terminal through the HLR upon receipt of a call connection request to the called terminal from the first APC, and transmitting a paging message to the detected location of the called terminal;
a second MSC for transmitting a request message for the call connection to the called terminal upon receipt of the call connection request to the called terminal from the first MSC; and
a second APC for transmitting a termination message to the called terminal upon receipt of the request message from the second MSC.

21. The network interworking system of claim 20, wherein:
the terminal identifier comprises a mobile identification number (MIN); and
the origination message comprises a session initiation protocol (SIP) invite request message generated by representing the terminal identifier in the form of a SIP uniform resource locator (URL).

22. The network interworking system of claim 20, wherein the termination message comprises a SIP invite request message.

23. The network interworking system of claim 20, wherein the origination message further comprises:
an electronic serial number (ESN) of the calling terminal, and the HLR is configured to determine whether the calling terminal is a registered terminal by analyzing the ESN included in the origination message and provide location information of the called terminal to the first MSC if the calling terminal is a registered terminal.

24. A network interworking method for connecting a voice call from a calling terminal in a wireless packet network that provides voice over Internet protocol (VoIP) service to a called terminal in a mobile communication network that provides circuit-switched voice service, the method comprising the steps of:
registering location information of terminals and a subscriber profile in a home location register (HLR);
transmitting an origination message including a terminal identifier of the called terminal to an access point controller (APC) in the wireless packet network;
converting data between the mobile communication network and the wireless packet network, and transmitting a call connection request to the called terminal; and
detecting a location of the called terminal in the mobile communication network through the HLR, and transmitting a paging message to the detected location of the called terminal.

25. The network interworking method of claim 24, wherein:
the terminal identifier comprises a mobile identification number (MIN); and
the origination message comprises a session initiation protocol (SIP) invite request message generated by representing the terminal identifier in the form of a SIP uniform resource locator (URL).

26. The network interworking method of claim 24, wherein the origination message further comprises:
an electronic serial number (ESN) of the calling terminal, and the step of transmitting a call connection request comprises the step of determining whether the calling terminal is a registered terminal by analyzing the ESN included in the origination message and providing location information of the called terminal to the first MSC in which the calling terminal is registered if the calling terminal is a registered terminal.

27. A network interworking method for connecting a voice call from a calling terminal in a mobile communication network that provides circuit-switched voice service to a called terminal in a wireless packet network that provides voice over Internet protocol (VoIP) service, the method comprising the steps of:
registering location information of terminals and a subscriber profile in a home location register (HLR);
transmitting an origination message including a terminal identifier of the called terminal to a base station system (BSS) in the mobile communication network;
transmitting a call connection request to a mobile switching center (MSC) based on the mobile identifier of the called terminal;
detecting a location of the called terminal in the wireless packet network through the HLR, and transmitting a paging message to the detected location of the called terminal; and
converting data between the mobile communication network and the wireless packet network, and transmitting a call connection request to the called terminal.

28. The network interworking method of claim 27, further comprising the step of transmitting a session initiation protocol (SIP) invite request message generated by representing the terminal identifier in the form of a SIP uniform resource locator (URL) upon receipt of the call connection request to the called terminal, wherein the terminal identifier comprises a mobile identification number (MIN).

29. The network interworking method of claim 27, wherein the origination message further comprises:
an electronic serial number (ESN) of the calling terminal, and the step of transmitting a call connection request comprises the step of determining whether the calling terminal is a registered terminal by analyzing the ESN included in the origination message and transmitting a circuit identity code (CIC) allocation message to the MSC in which the calling terminal is registered.

30. An access point controller (APC) apparatus included in a network interworking system for connecting a voice call between a mobile terminal in a wireless packet network that provides voice over Internet protocol (VoIP) service and a mobile terminal in a mobile communication network that provides circuit-switched voice service, the apparatus comprising:
a signaling gateway including a session initiation protocol (SIP) message handler for handling transmission/reception of SIP-based messages for voice call connection with mobile terminals in the wireless packet network and the mobile communication network, and a mobile switching center (MSC) interworking unit for exchanging a message including call setup information between the mobile terminals, with an MSC; and
a media gateway connected to the signaling gateway via a predetermined control protocol, for performing data conversion between the wireless packet network and the mobile communication network.

31. The APC apparatus of claim 30, wherein for call connection from the mobile communication network to the wireless packet network, the SIP message handler transmits a SIP invite request message indicating arrival of a voice call to the mobile terminal in the wireless packet network, when the MSC interworking unit detects receipt of a paging request message including a terminal identifier of the mobile terminal in the wireless packet network.

32. The APC apparatus of claim 30, wherein for call connection from the wireless packet network to the mobile communication network, the MSC interworking unit transmits a message including call setup information to the MSC after completion of circuit identity code (CIC) allocation, when the SIP message handler detects receipt of a SIP invite request message including a terminal identifier of the mobile terminal in the mobile communication network.

33. A location registration method for a mobile terminal located in a wireless packet network in a network interworking system having an access point controller (APC) for handling call connection between a first mobile terminal in the wireless packet network and a second mobile terminal in a mobile communication network, the method comprising the steps of:
transmitting a session initiation protocol (SIP) registration request message including a mobile identification number (MIN) and electronic serial number (ESN) to the APC;
transmitting a location update request message to a mobile switching center (MSC);
transmitting a location registration request message including the MIN and the ESN to a home location register (HLR);
determining whether the first mobile terminal is a registered terminal by analyzing the MIN and the ESN, and transmitting a location registration response message including a corresponding subscriber profile to the MSC if the first mobile terminal is a registered terminal; and
registering a location of the first mobile terminal in a visitor location register (VLR) based on the subscriber profile.

34. The location registration method of claim 33, further comprising the steps of:
transmitting a SIP registration request message with a lifetime field indicating a location registration period, which is set to ‘0’, to the APC;
transmitting a location update request message to the MSC;
transmitting a location deregistration request message to the HLR, and receiving a response message from the HLR; and
deregistering a location of the first mobile terminal based on the subscriber profile.

35. A network interworking system for providing short message service (SMS) service from a calling terminal in a wireless packet network to a called terminal in a circuit-switched mobile communication network, the system comprising:
a home location register (HLR) for registering therein location information of terminals and a subscriber profile;
an access point controller (APC) including a gateway for connection with the mobile communication network, for converting data between the mobile communication network and the wireless packet network using the gateway upon receipt of an origination message including an SMS message and a terminal identifier of the called terminal from the calling terminal, and transmitting an SMS delivery message including the SMS message and the terminal identifier;
an origination mobile switching center (MSC) for detecting a location of the called terminal through the HLR upon receipt of the origination message including the terminal identifier of the called terminal from the APC, and transmitting a first delivery message to the detected location of the called terminal;
an SMS center (SMSC) for, upon receiving the first delivery message, transmitting a second delivery message including the SMS message and the terminal identifier to the location of the called terminal, detected through the HLR; and
a termination MSC for, upon receiving the second delivery message, transmitting a paging message indicating arrival of the SMS message to the called terminal.

36. The network interworking system of claim 35, wherein:
the terminal identifier comprises a mobile identification number (MIN); and
the origination message comprises a session initiation protocol (SIP) invite request message generated by representing the terminal identifier in the form of a SIP uniform resource locator (URL).

37. The network interworking system of claim 35, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

38. The network interworking system of claim 35, wherein the APC uses an application data delivery service (ADDS) transfer message as the SMS delivery message when a SIP invite request message is received as the origination message.

39. The network interworking system of claim 35, wherein each of the first delivery message and the second delivery message comprises an SMS delivery point to point (SMDPP) message based on an interim standard-41 mobile application part (IS-41 MAP).

40. The network interworking system of claim 35, wherein the APC comprises:
a signaling gateway comprising:
a SIP message handler for handling transmission/reception of SIP-based messages for SMS message delivery between the calling terminal and the called terminal; and
an MSC/SMSC interworking unit for exchanging an SMS delivery message including an SMS message and a terminal identifier of the called terminal, with the origination MSC; and
a media gateway connected to the signaling gateway via a predetermined control protocol, for performing data conversion between the wireless packet network and the mobile communication network.

41. A network interworking system for providing short message service (SMS) service from a calling terminal in a circuit-switched mobile communication network to a called terminal in a wireless packet network, the system comprising:
a home location register (HLR) for registering therein location information of terminals and a subscriber profile;
an origination mobile switching center (MSC) for transmitting a first delivery message including an SMS message and a terminal identifier of the called terminal, upon receiving an origination message including the SMS message and the terminal identifier of the called terminal from the calling terminal through a base station system (BSS);
an SMS center (SMSC) for, upon receiving the first delivery message, transmitting a second delivery message including the SMS message and the terminal identifier to a location of the called terminal, detected through the HLR;
a termination MSC for, upon receiving the second delivery message, transmitting a paging request message indicating arrival of the SMS message to the called terminal; and
an access point controller (APC) including a gateway for connection with the mobile communication network, for converting data between the mobile communication network and the wireless packet network using the gateway upon receipt of the paging request message from the termination MSC, and transmitting a termination message including the SMS message and the terminal identifier.

42. The network interworking system of claim 41, wherein:
the terminal identifier comprises a mobile identification number (MIN); and
the termination message comprises a session initiation protocol (SIP) invite request message generated by representing the terminal identifier in the form of a SIP uniform resource locator (URL).

43. The network interworking system of claim 41, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

44. The network interworking system of claim 41, wherein each of the first delivery message and the second delivery message comprises an SMS delivery point to point (SMDPP) message based on an interim standard-41 mobile application part (IS-41 MAP).

45. The network interworking system of claim 41, wherein the APC comprises:
a signaling gateway comprising:
a SIP message handler for handling transmission/reception of SIP-based messages for SMS message delivery between the calling terminal and the called terminal; and
an MSC/SMSC interworking unit for exchanging an SMS delivery message including an SMS message and a terminal identifier of the called terminal, with the origination MSC; and
a media gateway connected to the signaling gateway via a predetermined control protocol, for performing data conversion between the wireless packet network and the mobile communication network.

46. A network interworking system for providing short message service (SMS) service from a calling terminal in a first wireless packet network to a called terminal in a second wireless packet network, the system comprising:
a home location register (HLR) for registering therein location information of terminals and a subscriber profile;
an origination access point controller (APC) for transmitting an SMS delivery message including an SMS message and a terminal identifier of the called terminal upon receipt of an origination message including the SMS-message and the terminal identifier from the calling terminal;
an origination mobile switching center (MSC) for, upon receiving the SMS delivery message, transmitting a first delivery message including the SMS message and the terminal identifier;
an SMS center (SMSC) for, upon receiving the first delivery message, transmitting a second delivery message including the SMS message and the terminal identifier to a location of the called terminal, detected through the HLR;
a termination MSC for, upon receiving the second delivery message, transmitting a request message indicating arrival of the SMS message to the called terminal; and
a termination APC including a gateway for connection with the mobile communication network, for converting data between the mobile communication network and the wireless packet network using the gateway upon receipt of the request message, and transmitting a termination message including the SMS message and the terminal identifier

47. The network interworking system of claim 46, wherein:
the terminal identifier comprises a mobile identification number (MIN); and
the termination message comprises a session initiation protocol (SIP) invite request message generated by representing the terminal identifier in the form of a SIP uniform resource locator (URL).

48. The network interworking system of claim 46, wherein the origination message further comprises:
an electronic serial number (ESN) of the calling terminal, and the HLR is configured to determine whether the calling terminal is a registered terminal by analyzing the ESN included in the origination message and provide location information of the called terminal to the SMSC if the calling terminal is a registered terminal.

49. The network interworking system of claim 46, wherein each of the first delivery message and the second delivery message comprises an SMS delivery point to point (SMDPP) message based on an interim standard-41 mobile application part (IS-41 MAP).

50. A network interworking method for providing short message service (SMS) service from a calling terminal in a wireless packet network to a called terminal in a circuit-switched mobile communication network, the method comprising the steps of:
registering location information of terminals and a subscriber profile in a home location register (HLR);
transmitting an origination message including an SMS message of the calling terminal and a terminal identifier of the called terminal to an access point controller (APC);
transmitting an SMS delivery message to an origination mobile switching center (MSC) upon receipt of the origination message;
transmitting a first delivery message including the SMS message and the terminal identifier to an SMS center (SMSC) upon receipt of the SMS delivery message;
transmitting a second delivery message including the SMS message and the terminal identifier to a termination MSC upon receipt of the first delivery message, and
transmitting a request message indicating arrival of the SMS message to the called terminal through a base station system (BSS) upon receipt of the second delivery message.

51. The network interworking method of claim 50, wherein the SMS delivery message comprises an application data delivery service (ADDS) transfer message.

52. The network interworking method of claim 50, wherein each of the first delivery message and the second delivery message comprises an SMS delivery point to point (SMDPP) message based on an interim standard-41 mobile application part (IS-41 MAP).

53. The network interworking method of claim 50, wherein the origination message comprises a session initiation protocol (SIP) invite request message generated by representing the terminal identifier in the form of a SIP uniform resource locator (URL).

54. A network interworking method for providing short message service (SMS) service from a calling terminal in a first wireless packet network to a called terminal in a second wireless packet network, the method comprising the steps of:
registering location information of terminals and a subscriber profile in a home location register (HLR);
transmitting an origination message including an SMS message of the calling terminal and a terminal identifier of the called terminal to an access point controller (APC);
transmitting an SMS delivery message to an origination mobile switching center (MSC) upon receipt of the origination message;
transmitting a first delivery message including the SMS message of the calling terminal and the terminal identifier of the called terminal to an SMS center (SMSC) upon receipt of the SMS delivery message;
transmitting a second delivery message including the SMS message and the terminal identifier to a termination MSC upon receipt of the first delivery message;
transmitting a paging request message indicating arrival of the SMS message to the APC upon receipt of the second delivery message; and
transmitting a termination message including the SMS message and the terminal identifier to the called terminal upon receipt of the paging request message.

55. The network interworking method of claim 54, wherein the SMS delivery message comprises an application data delivery service (ADDS) transfer message.

56. The network interworking method of claim 54, wherein each of the first delivery message and the second delivery message comprises an SMS delivery point to point (SMDPP) message based on an interim standard-41 mobile application part (IS-41 MAP).

57. The network interworking method of claim 54, wherein the termination message comprises a session initiation protocol (SIP) invite request message generated by representing the terminal identifier in the form of a SIP uniform resource locator (URL).

58. A network interworking method for providing short message service (SMS) service from a calling terminal in a first wireless packet network to a called terminal in a second wireless packet network, the method comprising the steps of:
registering location information of terminals and a subscriber profile in a home location register (HLR);
transmitting an origination message including an SMS message of the calling terminal and a terminal identifier of the called terminal to an origination access point controller (APC);
transmitting an SMS delivery message to an origination mobile switching center (MSC) upon receipt of the origination message;
transmitting a first delivery message including the SMS message and the terminal identifier to an SMS center (SMSC) upon receipt of the SMS delivery message;
transmitting a second delivery message including the SMS message and the terminal identifier to a location of the called terminal, detected through the HLR, upon receipt of the first delivery message;
transmitting a request message indicating arrival of the SMS message to a termination APC upon receipt of the second delivery message; and
transmitting a termination message to the called terminal upon receipt of the request message.

59. The network interworking method of claim 58, wherein the SMS delivery message comprises an application data delivery service (ADDS) transfer message.

60. The network interworking method of claim 58, wherein each of the first delivery message and the second delivery message comprises an SMS delivery point to point (SMDPP) message based on an interim standard-41 mobile application part (IS-41 MAP).

61. The network interworking method of claim 58, wherein the termination message comprises a session initiation protocol (SIP) invite request message generated by representing the terminal identifier in the form of a SIP uniform resource locator (URL).

62. An access point controller (APC) apparatus included in a network interworking system for providing short message service (SMS) service between a mobile terminal in a wireless packet network and a mobile terminal in a mobile communication network, the apparatus comprising:
a signaling gateway comprising:
a session initiation protocol (SIP) message handler for handling transmission/reception of SIP-based messages for delivery of an SMS message between mobile terminals in the wireless packet network and the mobile communication network; and
a mobile switching center (MSC)/SMS center (SMSC) interworking unit for exchanging an SMS delivery message including an SMS message and a terminal identifier of a mobile terminal to which the SMS message is targeted, with an MSC; and
a media gateway connected to the signaling gateway via a predetermined control protocol, for performing data conversion between the wireless packet network and the mobile communication network.
